(19) United States
(12) Patent Application Publication
(10) Pub. No.: US 2002/0037668 A1
(43) Pub. Date: Mar. 28, 2002

(54) Modular housing system for electronics devices

(75) Inventors: George Tseng, Los Angeles, CA (US); David Roth, Los Angeles, CA (US); David Goetz, Los Angeles, CA (US); Eric Roth, Santa Monica, CA (US)

Correspondence Address: NEXT PLANET, IN.C, 175 S. FAIR OAKS AVE., PASADENA, CA, 91105, US

(73) Assignee: Next Planet, Inc., Los Angeles, CA (US)

(21) Appl. No.: 09/849,183

(22) Filed: May 5, 2001

Related U.S. Application Data
(63) Continuation-in-part of application No. 09/653,481, filed on Sep. 1, 2000.

(51) Int. Cl. H01R 4/60

(52) U.S. Cl. 439/660

(57) ABSTRACT

A housing for a device including a first surface having a connector disposed thereon, the connector configured to mechanically couple to an oppositely mated connector on a second surface of a second device. The first surface also has a set of surface features disposed thereon, the set of surface features configured to engage an oppositely mirroring set of surface features on the second surface. When the device is stacked with the second device, the connector and the set of surface features of the first surface interact with the oppositely mated connector and the oppositely mirroring set of surface features on the second surface, respectively, to prevent vertical separation and horizontal dislocation between the device and the second device.

### CROSS-REFERENCE

The present application is a continuation-in-part of application Ser. No. 09/653,481, filed Sep. 1, 2000, entitled “Circular Connector System,” by inventors David Goetz and David Roth, currently pending (attorney docket number RP.P001). This application is incorporated herein by reference.

### BACKGROUND

Electronic equipment is becoming ubiquitous in the modern household. A consumer may own one or more devices, such as set-top boxes, multimedia game players, stereos, computers, Internet appliances and other home entertainment devices. From time to time, a consumer will desire to add additional components to the system by purchasing an electronic device. However, current electronic equipment does not provide a convenient mechanism for interfacing additional devices or components. Current systems do not allow additional electronic devices or components to be added to an electronics device system to allow consumers to add additional electronic devices or components easily, without wasting space or requiring an additional wires or cables.

One possible solution that has been proposed is the creating of modular housings that are “stackable”, where each housing is identical in design and have matched “stacking surfaces.” However, devices may only be stacked with other devices from the same family (e.g., devices that have the same surfaces). In addition, this solution does not eliminate the need to interconnect the devices with cables after the devices have been stacked.

Thus, a system that addresses one or more of the above problems is desirable.

### BRIEF DESCRIPTION OF THE DRAWINGS

The system is illustrated by way of example and not limitation in the figures of the accompanying drawings in which like references indicate similar elements and in which:

FIG. 1 is a top-down view of a first electronics device configured in accordance with one embodiment of the present invention.

FIG. 2 is a bottom-up view of the first electronics device of FIG. 1.

FIG. 3 is a side view of the first electronics device of FIG. 1.

FIG. 4 is a perspective view of the first electronics device of FIG. 1.

FIG. 5 is a top-down view of a second electronics device configured in accordance with one embodiment of the present invention.

FIG. 6 is a bottom-up view of the second electronics device of FIG. 5.

FIG. 7 is a side view of the second electronics device of FIG. 5.

FIG. 8 is a perspective view of the second electronics device of FIG. 5.

FIG. 9 is a front view of the second electronics device being placed on top of the first electronics device.

FIG. 10 is a side view of the second electronics device being placed on top of the first electronics device.

FIG. 11 is a perspective view of the second electronics device being placed on top of the first electronics device.

FIG. 12 is a front view of the second electronics device after it has been placed on top of the first electronics device.

FIG. 13 is a side view of the second electronics device after it has been placed on top of the first electronics device.

FIG. 14 is a perspective view of the second electronics device after it has been placed on top of the first electronics device.

FIG. 15 is a top-down view of a first modular electronics device configured in accordance with one embodiment of the present invention.

FIG. 16 is a bottom-up view of the first modular electronics device of FIG. 1.

FIG. 17 is a side view of the first modular electronics device of FIG. 1.

FIG. 18 is a perspective view of the first modular electronics device of FIG. 1.

FIG. 19 is a top-down view of a second modular electronics device configured in accordance with one embodiment of the present invention.

FIG. 20 is a bottom-up view of the second modular electronics device of FIG. 19.

FIG. 21 is a side view of the second modular electronics device of FIG. 19.

FIG. 22 is a perspective view of the second modular electronics device of FIG. 19.

FIG. 23 is a front view of the second modular electronics device being placed on top of the first modular electronics device.

FIG. 24 is a side view of the second modular electronics device being placed on top of the first modular electronics device.

FIG. 25 is a perspective view of the second modular electronics device being placed on top of the first modular electronics device.

FIG. 26 is a front view of the second modular electronics device after it has been placed on top of the first modular electronics device.

FIG. 27 is a side view of the second modular electronics device after it has been placed on top of the first modular electronics device.

FIG. 28 is a perspective view of the second modular electronics device after it has been placed on top of the first modular electronics device.

FIG. 29 is a functional block diagram of first electronics device and second electronics device.

FIG. 30 is a functional block diagram of first modular electronics device, second modular electronics device, and a third modular electronics device.

FIG. 31 is an isometric view of a plug connector in one embodiment of the present invention.

FIG. 32 is an isometric view of a receptacle connector in one embodiment of the present invention.

FIG. 33 is a cross-sectional view of the plug connector in proximity to the receptacle connector.

FIG. 34 is a cross-sectional view of an alternate embodiment of the plug connector in proximity to an alternate embodiment of the receptacle connector.

### DETAILED DESCRIPTION

The present invention discloses a modular housing system for electronic devices. In the following description, numerous specific details are set forth in order to provide a thorough understanding of the present invention. However, it will be apparent to one skilled in the art that the present invention may be practiced without these specific details. In other instances, well-known circuits, structures, and the like are not described in detail so as not to obscure the present invention unnecessarily. Moreover, although the present invention is described with reference to a set top box, it will be appreciated that the invention has application to other systems where electronic devices must be mechanically and electrically coupled together. Accordingly, the specific reference to a modular set-top box in this Specification is not to be understood as a limitation in the application of the invention.

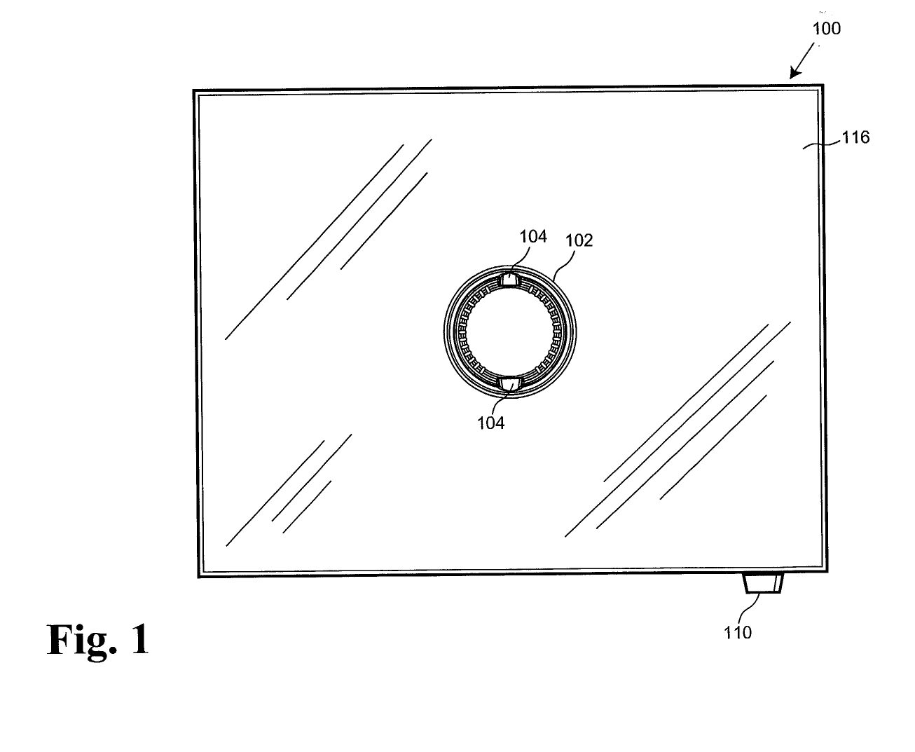

FIG. 1 is a top-down view of a first electronics device 100. First electronics device 100 has a top surface 116 and a top connector 102 located thereon. As shown in FIG. 1, top connector 102 is a connector as substantially disclosed in a patent application entitled “Circular Connector System,” filed Oct. 1, 2000 (Circular Connector System). Top connector 102 includes a set of top connector keying elements 104 used for alignment with an oppositely mated connector, which is further discussed herein. In one embodiment, as described herein, first electronics device 100 contains electronics to provide set top box functionality such as television tuning, digital audio encoding/decoding, digital video encoding/decoding, and data storage. In other embodiments, first electronics device 100 may be used to house other electronic components including, but not limited to, hard disk drives, printed circuit boards (PCB), and other devices. First electronics device 100 also includes a switch 110 for controlling first electronics device 100 along with the use of a remote control unit.

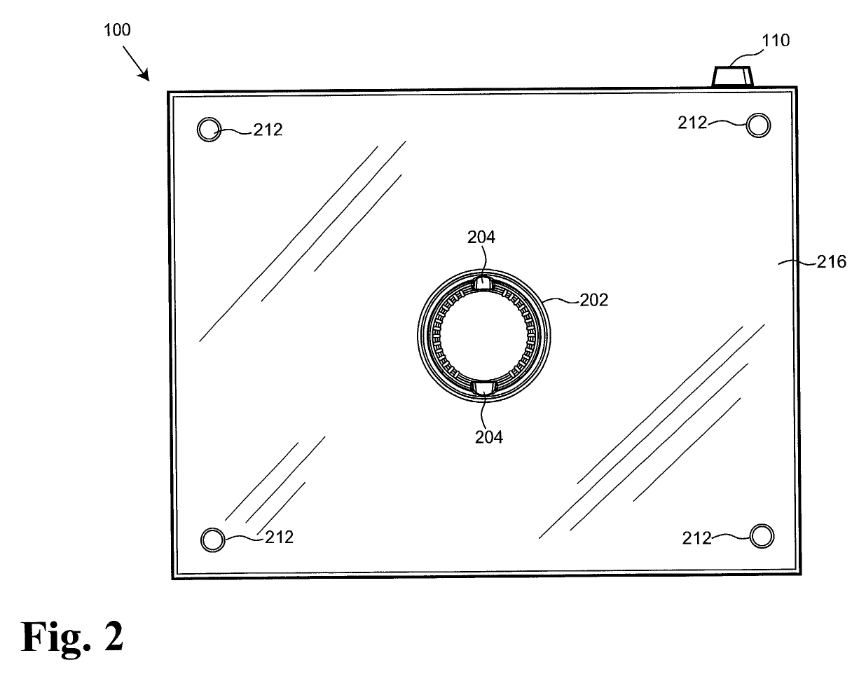

FIG. 2 is a bottom-up view of first electronics device 100. First electronic device 100 has a bottom surface 216 and a bottom connector 202 located thereon. In one embodiment, bottom connector 202 is recessed in bottom surface 216 and does not extend below bottom surface 216. First electronic device 100 also includes a set of feet 212 on bottom surface 216 useful for providing spacing between bottom surface 216 and another device or any surface on which first electronics device 100 is resting. Bottom connector 202 is the mating connector for top connector 102 as substantially disclosed in the Circular Connector System as referenced above, such that two electronics devices configured similarly to first electronics device 100 may be stacked on top of each other and be electrically and mechanically interconnected, as further described below. Bottom connector 202 has a set of bottom connector keying elements 204.

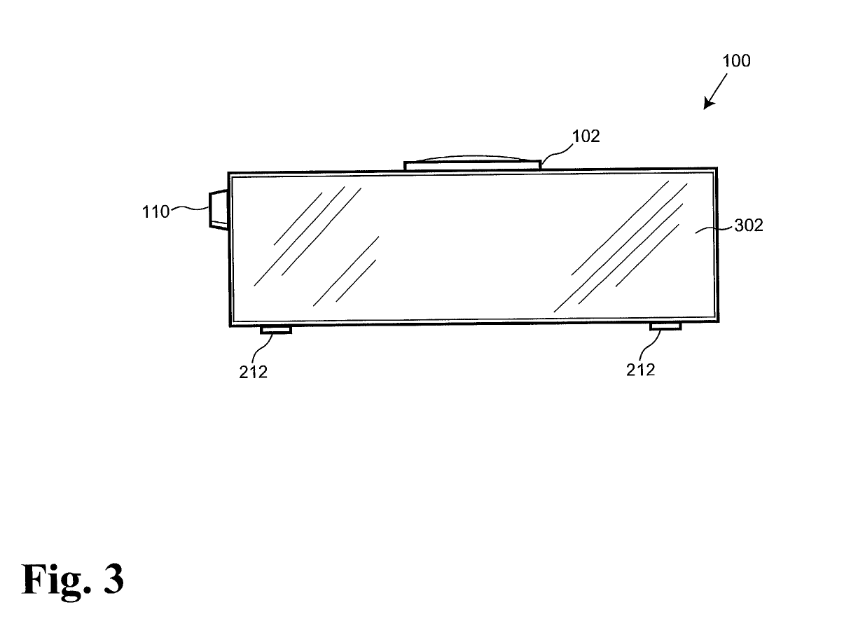

FIG. 3 is a left-side view of first electronics device 100, showing a left side surface 302 and a side view of top connector 102, switch 110 and set of feet 212. As mentioned above, bottom connector 202 is recessed in bottom surface 216 and does not extend below bottom surface 216. In another embodiment, the vertical alignment of bottom connector 202 may be lower and therefore extend below bottom surface 216.

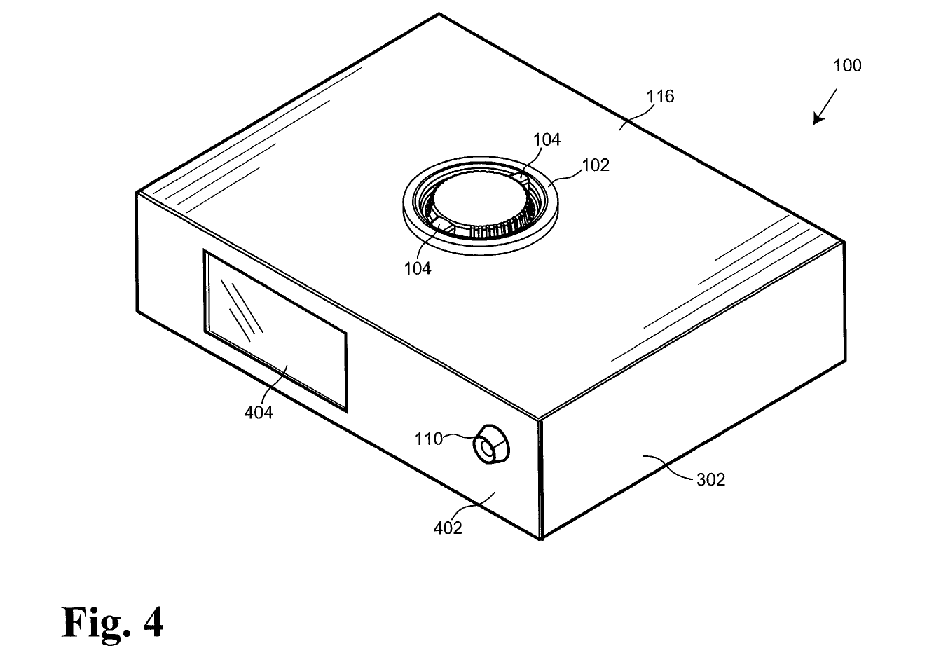

FIG. 4 is an orthogonal view of first electronics device 100, where a front surface 402 containing a display 404 and switch 110 is shown. Also shown in FIG. 4 is top surface 116 with top connector 102 and left side surface 302.

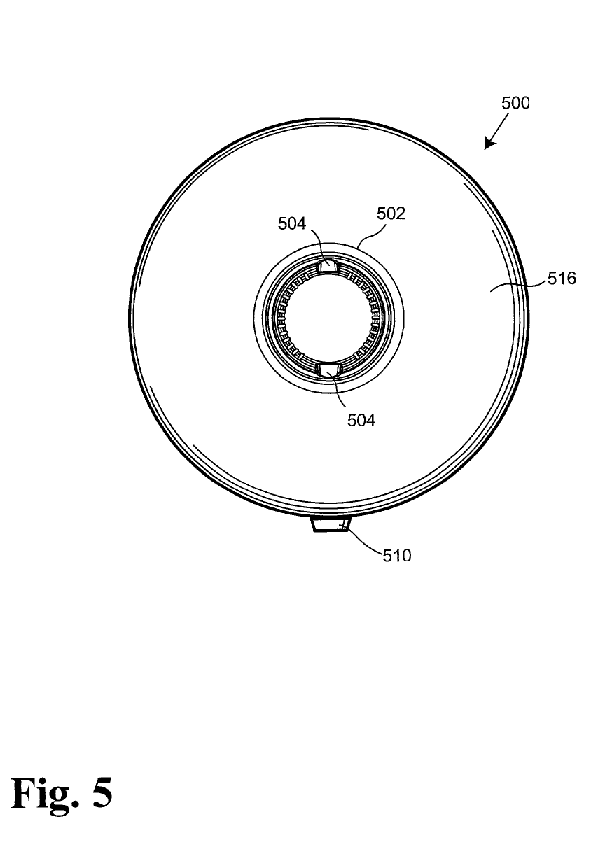

FIG. 5 is a top-down view of a second electronics device 500 with a top surface 516 having a top connector 502. Top connector 502 is a connector as disclosed in the Circular Connector System as referenced above for top connector 102 of first electronics device 100. Top connector 502 includes a set of top connector keying elements 504 used for alignment with an oppositely mated connector, which is further discussed herein. In one embodiment, second electronics device 500 houses electronics that add additional functionality to first electronics device 100. For example, second electronics device 500 may be a high definition television decoder module for decoding signals encoded according to a specification such as the Advanced Television (ATV) standards adopted by the Advanced Television Systems Committee (ATSC), found at http://www.atsc.org; the Grand Alliance High Definition Television (HDTV) System Specification Version 2.0, Dec. 7, 1994, downloadable at http://www.sarnoff.com/; or the Moving Pictures Experts Group (MPEG) Standard for encoding video and audio signals, MPEG-2, ISO/IEC JTC1/SC29/WG11, available at http://www.iso.ch. Second electronics device 500 also includes a switch 510 for controlling second electronics device 1500 along with the use of a remote control unit (not shown).

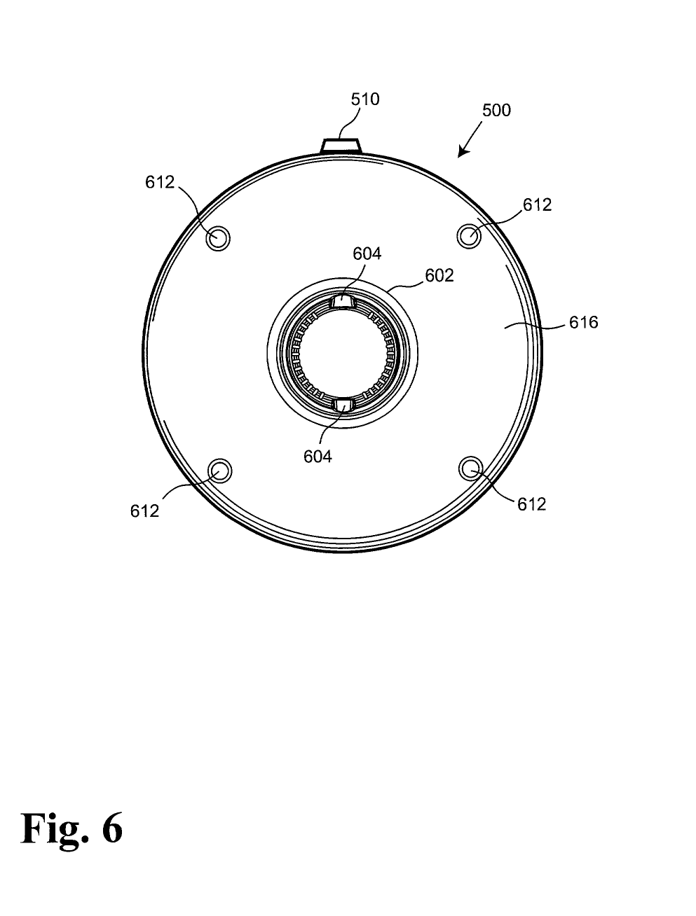

FIG. 6 is a bottom up view of second electronics device 500. Second electronic device 500 has a bottom surface 616 and a bottom connector 602 located thereon. In one embodiment, bottom connector 602 is recessed in bottom surface 616 and does not extend below bottom surface 616. Second electronic device 600 also includes a set of feet 612 on bottom surface 616 useful for providing spacing between bottom surface 216 and another device or any surface on which second electronics device 600 is resting. Bottom connector 602 is the mating connector for top connector 102 of first electronics device 100, such that second electronics device 600 may be stacked on top of first electronics device 100 and be electrically and mechanically interconnected. Bottom connector 602 has a set of bottom connector keying elements 604 which are mated to top connector keying elements 104 of first electronics device 100.

In one embodiment, top connector 502 is substantially identical to top connector 102 of first electronics device 100. Thus, top connector 502 is configured to mate to bottom connector 202 of first electronics device 100. In another embodiment, top connector 502 is of a different form factor from top connector 102. This would allow the configuration of stacking order through the use of different connectors such that a set of devices may only stack in a predetermined pattern.

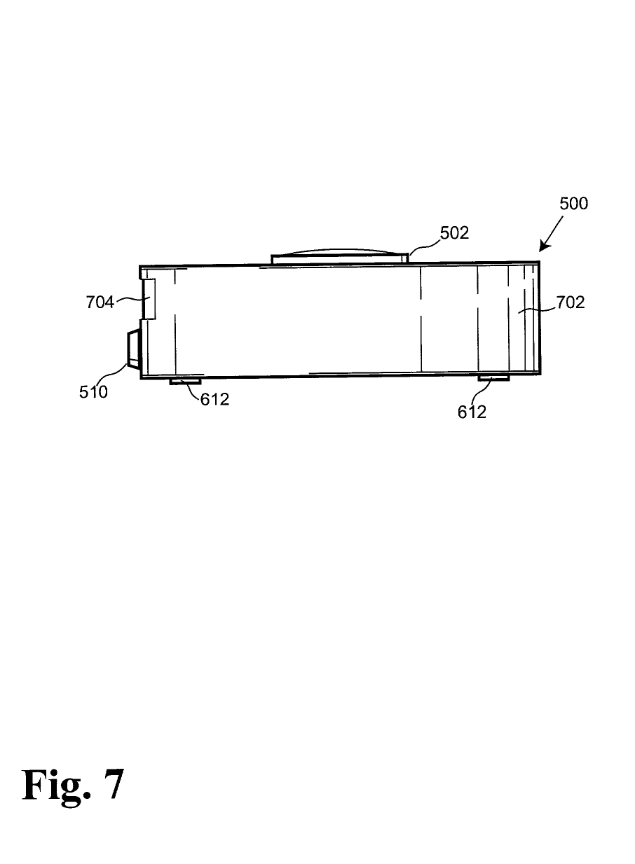

FIG. 7 is a left-side view of second electronics device 500, showing a side surface 702 and a side view of top connector 502, switch 510 and set of feet 612. As mentioned above, bottom connector 602 is recessed in bottom surface 616 and does not extend below bottom surface 616. In another embodiment, the vertical alignment of bottom connector 602 may be lower and therefore extend below bottom surface 616. Side surface 702 also includes a display 704.

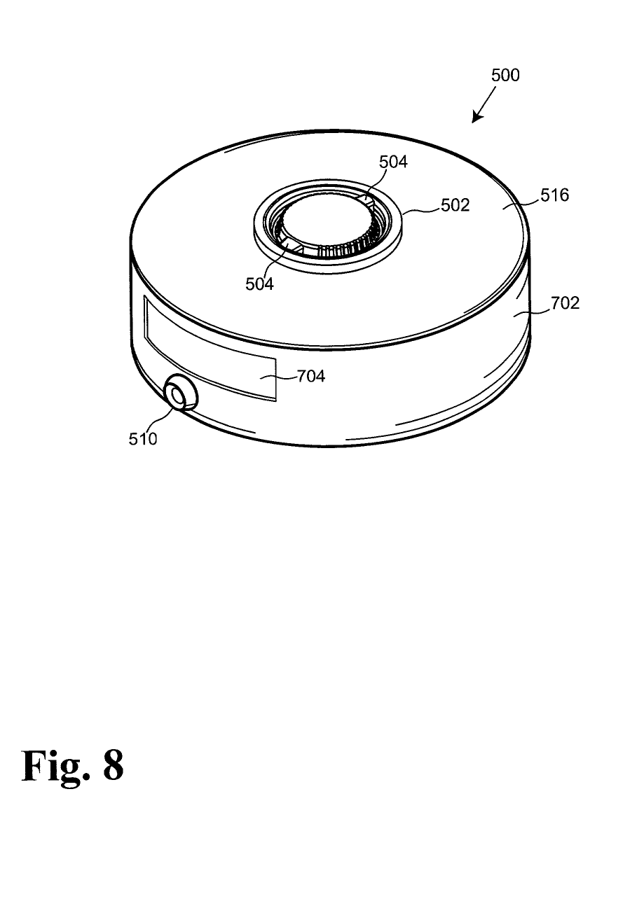

FIG. 8 is an orthogonal view of second electronics device 500, showing side surface 702 with a switch 510 and a display 704 located on the front thereof. Also shown is top connector 502 with keying elements 504 located on top of top surface 516.

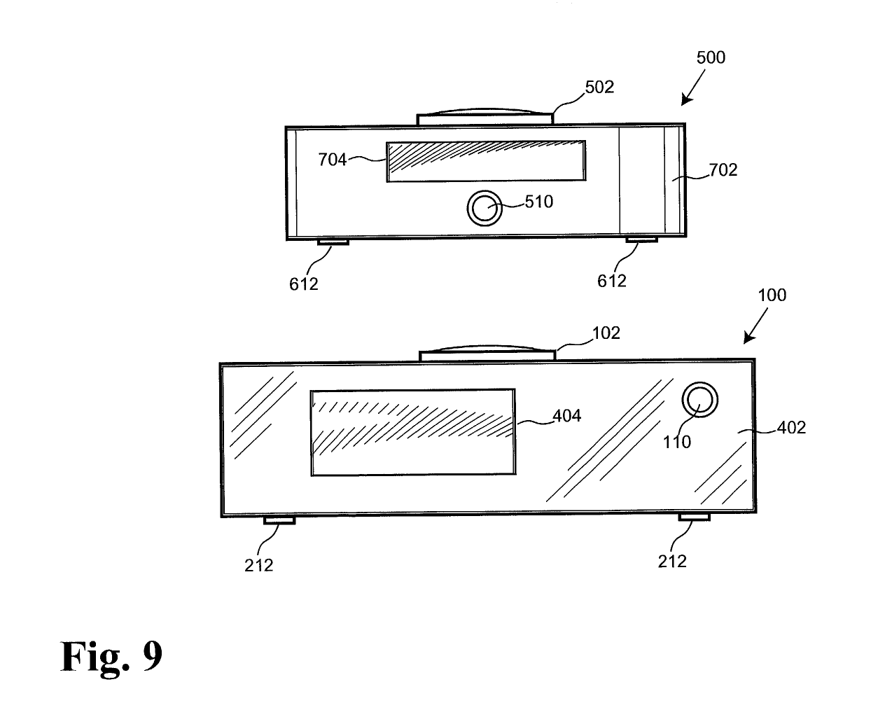

FIG. 9 is a front view of first electronics device 100 and second electronics device 500 in alignment to be vertically connected. Second electronics device 500 is placed above first electronics device 100 such that bottom connector 602 is aligned over top connector 102 of first electronics device 100.

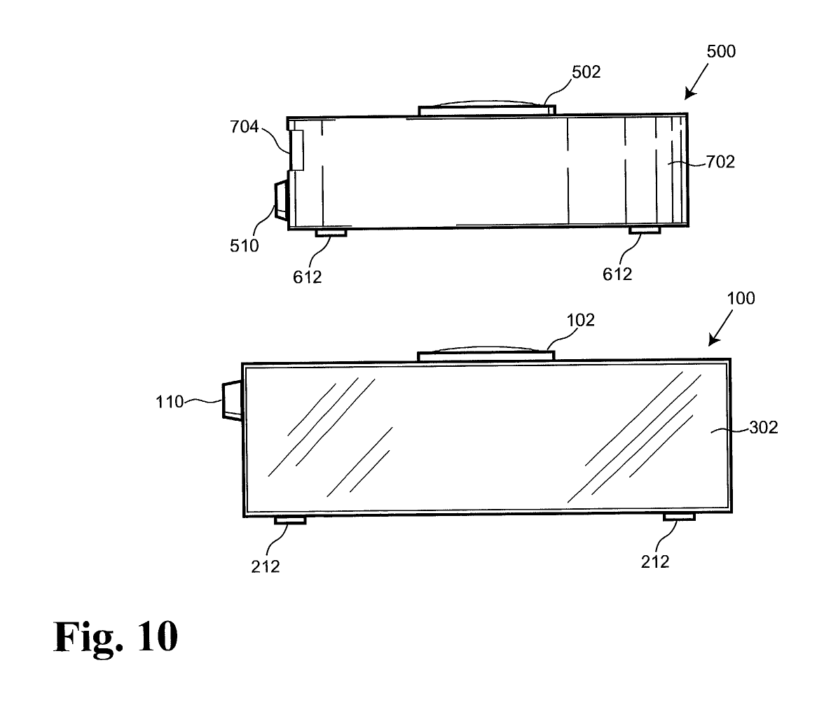

FIG. 10 is a side view of first electronics device 100 and second electronics device 500 in alignment to be vertically connected. Second electronics device 500 is placed above first electronics device 100 such that bottom connector 602 is aligned over top connector 102 of first electronics device 100.

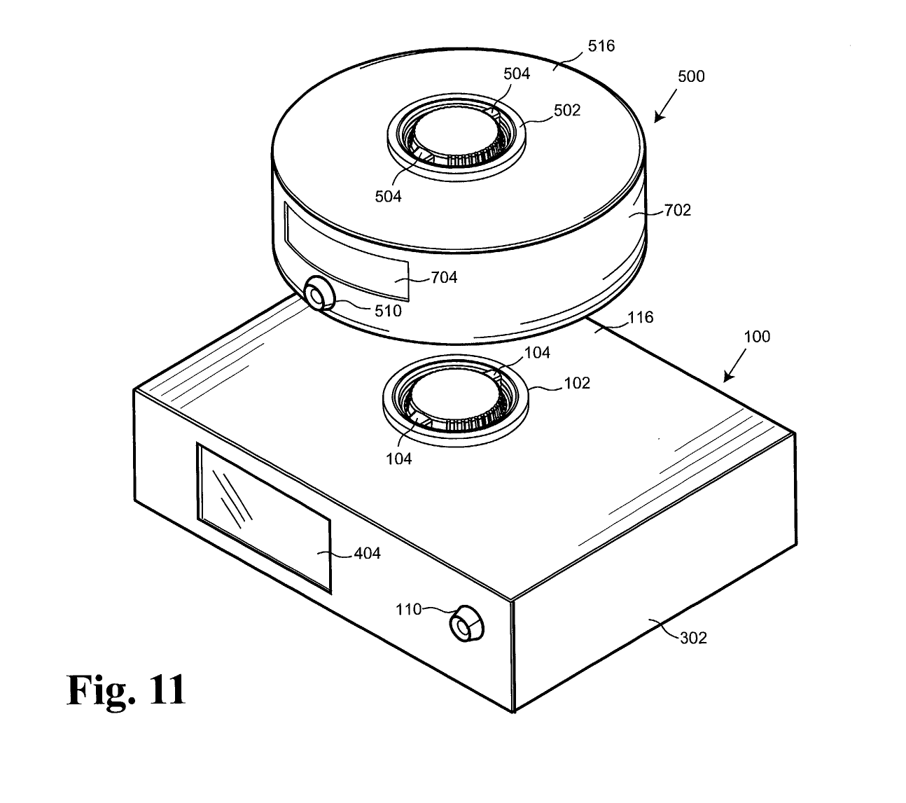

FIG. 11 is a perspective view of first electronics device 100 and second electronics device 500 in alignment to be vertically connected. Second electronics device 500 is placed above first electronics device 100 such that bottom connector 602 is aligned over top connector 102 of first electronics device 100. Rotational alignment of first electronics device 100 to second electronics device 500 is achieved by use of keying elements 104 on top connector 102 of first electronics device 100 and keying elements 604 on bottom connector 602 of second electronics device 500.

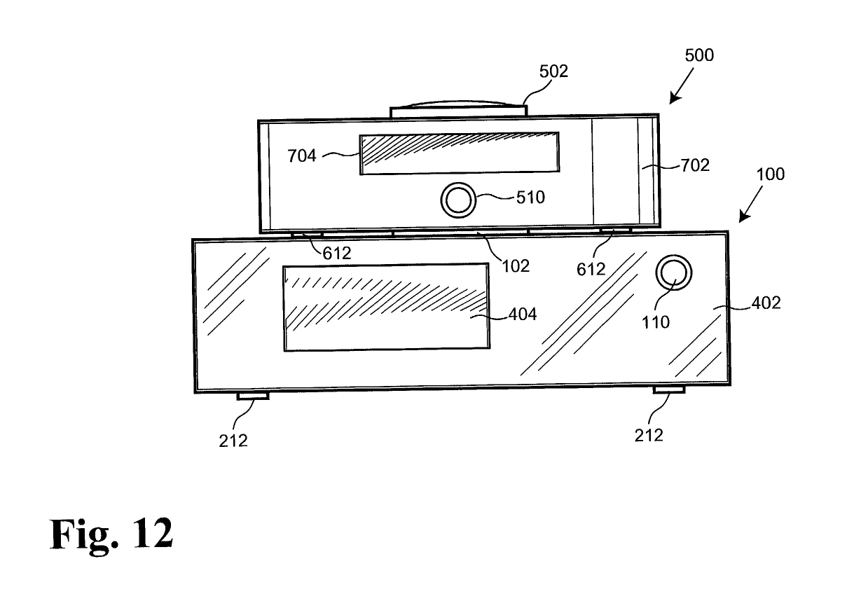

FIG. 12 is a front view of first electronics device 100 and second electronics device 500 vertically connected via top connector 102 and bottom connector 602, respectively. Second electronics device 500 is connected to first electronics device 100 such that bottom connector 602 of second electronics device 500 is mechanically and electrically in contact with top connector 102 of first electronics device 100. In one embodiment, spacing and standoff between first electronics device 100 and second electronics device 500 is achieved through set of feet 212. Height of set of feet 212 is designed to allow proper electrical connection and mechanical contact between top connector 102 of first electronics device 100 and bottom connector 602 of second electronics device 500. Depending on the height of set of feet 212 and the amount of standoff provided between bottom surface 216 of first electronics device 100 and the top surface of second electronics device 500, the vertical positioning of both top and bottom connectors may be adjusted.

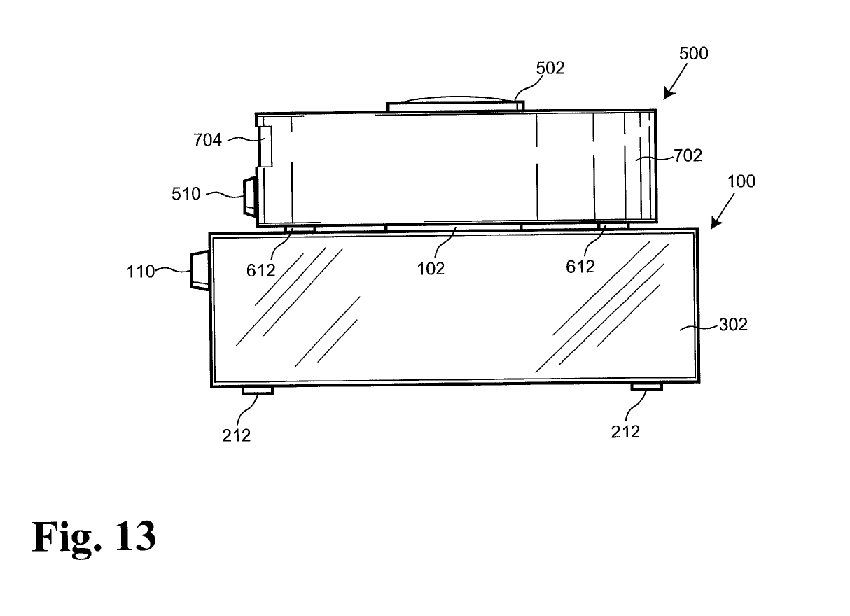

FIG. 13 is a side view of first electronics device 100 and second electronics device 500 after the devices have been stacked. Second electronics device 500 is placed above first electronics device 100 such that bottom connector 602 is aligned over top connector 102 of first electronics device 100.

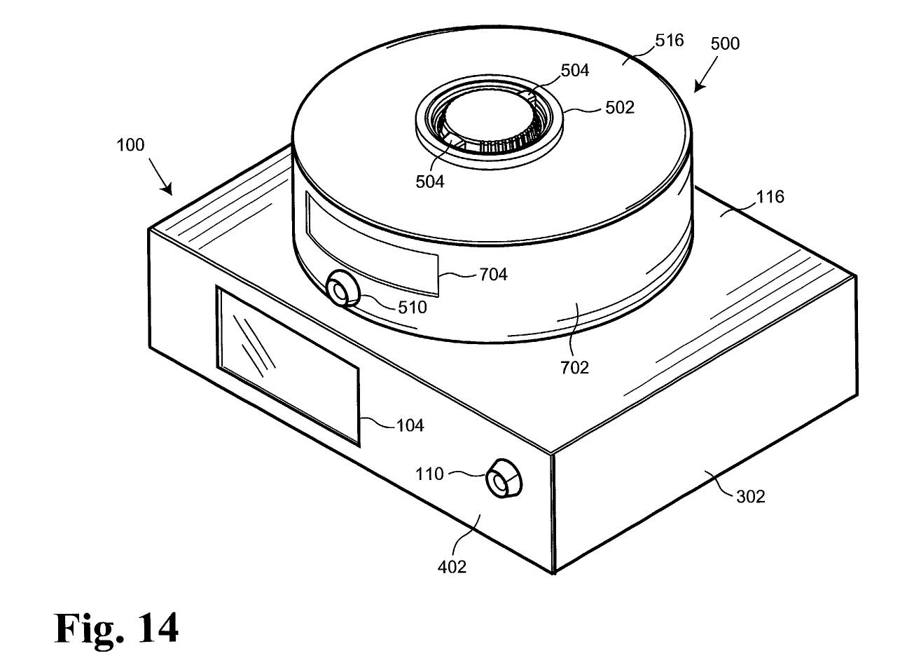

FIG. 14 is a perspective view of first electronics device 100 and second electronics device 500 after they have been stacked. Second electronics device 500 is placed above first electronics device 100 such that bottom connector 602 is in electrical and mechanical connection with top connector 102 of first electronics device 100. Rotational alignment of first electronics device 100 to second electronics device 500 is achieved by use of keying elements 104 on top connector 102 of first electronics device 100 and keying elements 604 on bottom connector 602 of second electronics device 500. In other embodiments, first electronics device 100 and second electronics device 500 may use a different configuration of connectors that offer substantially the same electrical and mechanical interconnection as top connector 102 of first electronics device 100 and bottom connector 602 of second electronics device 500. The electrical connection eliminates the need to use additional cables or wires between the devices, while the mechanical interconnects hold the devices together. These other connectors are described below. In addition, as mentioned above, the height of the connectors used may vary depending on how much spacing between the devices is desired. The connectors may also be mounted higher or lower in relation to the surfaces of the electronics devices.

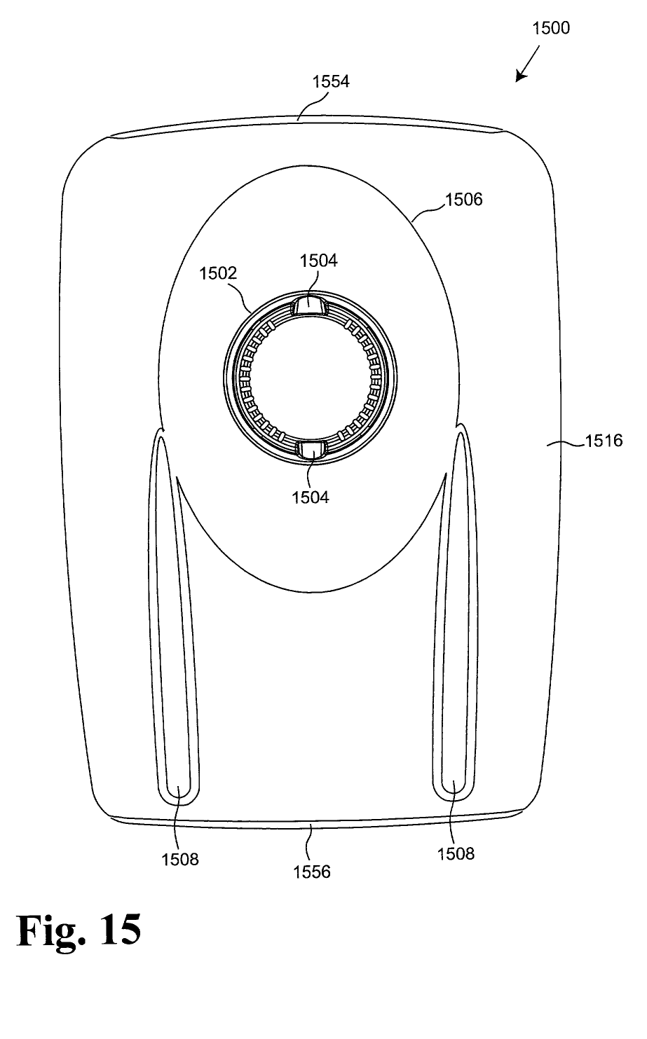

FIG. 15 is a top-down view of a first modular electronics device 1500 with a top surface 1516 configured in accordance with one embodiment of the present invention. First modular electronics device 1500 also has a front surface 1554 (e.g., a “front face”) and a back surface 1556 (e.g., “rear face”).

Top surface 1516 includes a top connector 1502 and a set of protrusions. In one embodiment, top connector 1502 is a connector as substantially disclosed in the Circular Connector System. In another embodiment, top connector 1502 may be any connector that provides for electrical contact when an oppositely mated connector is placed on top of it. In addition top connector 1502 also provides mechanical interconnectivity between first modular electronics device 1500 and a device that is stacked on it. Top connector 1502 has a set of keying/alignment elements 1504 to align the connectors and first modular electronics device 1500 to another electronics device.

The set of protrusions includes an oval convex surface 1506 and a set of rails 1508 in the surface of first modular electronics device 1500. The set of protrusions are used to assist in the alignment of first modular electronics device 1500 to appropriately configured electronic devices. In other embodiments, instead of oval convex surface 1506 or set of rails 1508, first modular electronics device 1500 may include other convex or concave surfaces. In yet another embodiment, the set of protrusions does not exist, and only set of keying/alignment elements 1504 of top connector 1502 is used for alignment.

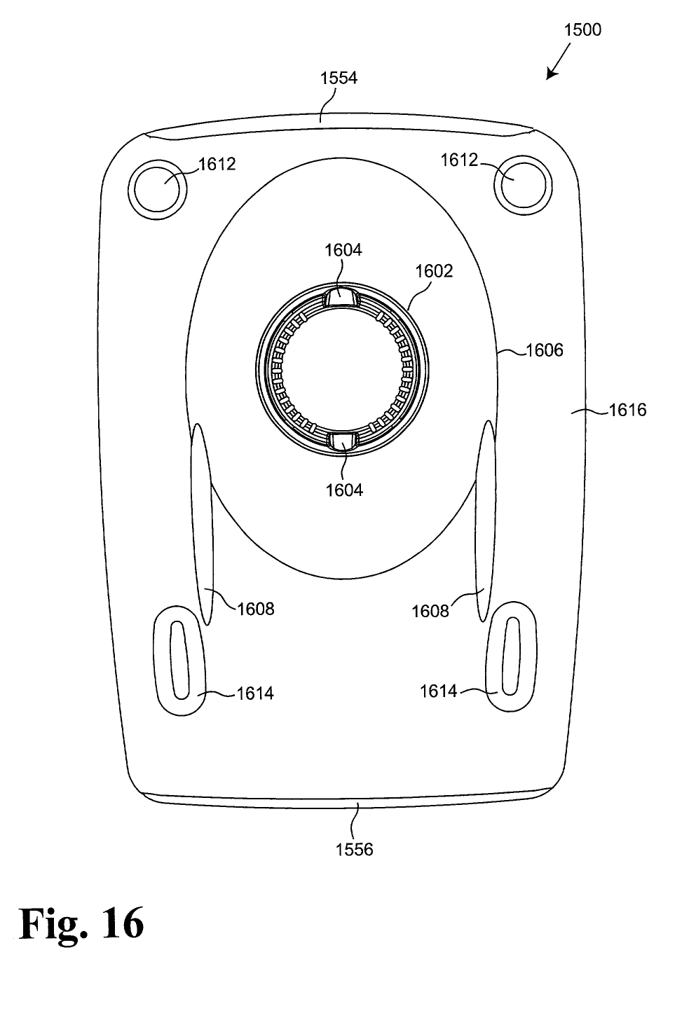

FIG. 16 is a bottom-up view of first modular electronics device 1500 showing a bottom surface 1616 with a bottom connector 1602 located thereon As shown, bottom connector 1602 is a connector as substantially disclosed the Circular Connector System, above. Bottom connector 1602 includes a set of keying/alignment elements 1604. Bottom surface 1616 also includes a set of front feet 1612 and a set of rear feet 1614. In addition, bottom surface 1616 includes an oval depression 1606 and a set of trenches 1608. Bottom surface 1616 also includes an oval concave surface 1606.

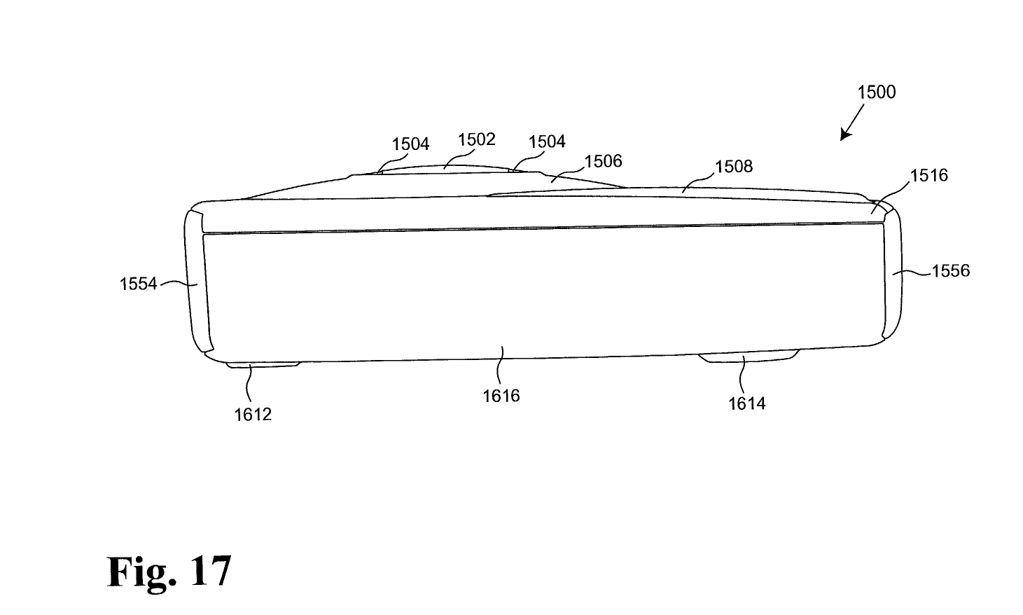

FIG. 17 is a side view of first modular electronics device 1500 illustrating the various vertical displacements of each of the elements on first modular electronics device 1500. In one embodiment, bottom surface 1616 is sloped upwards towards back surface 1556 and requires set of rear feet 1614 to be thicker than set of front feet 1612 such that top surface 1516 is of a certain horizontal orientation.

It is desirable that each modular electronics device, no matter how it is shaped, should contain standoff and stacking features (e.g., feet) to allow sufficient vertical space between each of the devices or the device and the surface on which the device is resting. In addition, the size of the standoff features should be proportional to the height of the top connectors on the devices versus the recess of the bottom connectors on the devices. Referring to FIG. 17, in the current embodiment, bottom connector 1602 should not protrude below bottom surface of bottom surface 1616. In another embodiment, bottom connector 1602 can protrude below bottom surface of bottom surface 1616, but not below set of front feet 1612 and set of rear feet 1614. In this embodiment, bottom connector 1602 may touch the surface on which the device is resting, in which case a short-circuit is a more likely occurrence if the surface on which the device is resting (e.g., a table top) is either electrically conductive (e.g., metal) or has substances on top of which that are electrically conductive (e.g., liquids on table top, paperclips or screws,).

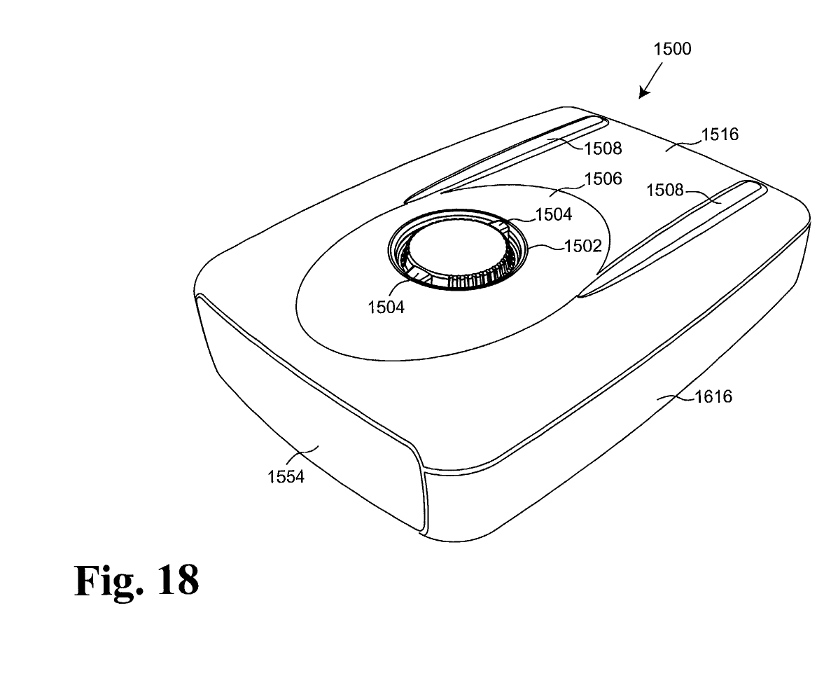

FIG. 18 is an orthogonal view of first modular electronics device 1500, where front surface 1554 and bottom surface 1616 is shown. Also shown in FIG. 18 is top connector 1502 with keying elements 1504, oval convex surface 1506, and top surface 1516 with set of rails 1508.

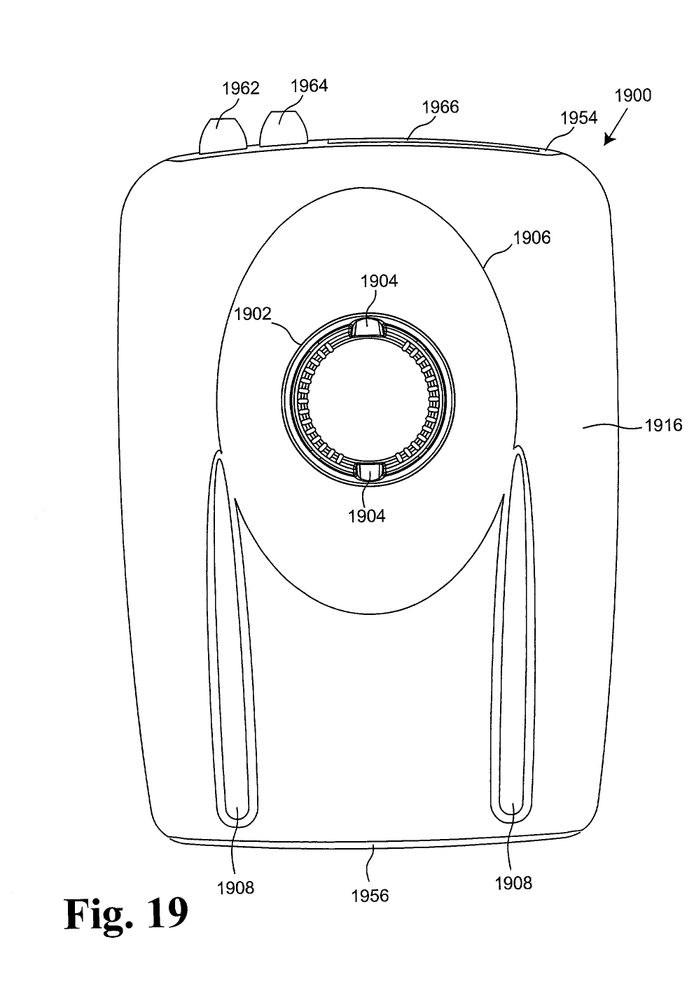

FIG. 19 is a top-down view of a second modular electronics device 1900 with a top surface 1916 configured in accordance with one embodiment of the present invention. Second modular electronics device 1900 also has a front surface 1954 (e.g., a “front face”) and a back surface 1956 (e.g., “rear face”). Front surface 1954 includes a first control 1962, a second control 1964, and a display 1966.

Top surface 1916 includes a top connector 1902 and a set of protrusions. In one embodiment, top connector 1902 is a connector as substantially disclosed in the Circular Connector System, above. In another embodiment, top connector 1902 may be any connector that provides for electrical contact when an oppositely mated connector is placed on top of it. In addition, top connector 1902 also provides mechanical interconnectivity between second modular electronics device 1900 and a device that is stacked on it. Top connector 1902 has a set of keying/alignment elements 1904 to align the connectors and second modular electronics device 1900 to another electronics device.

The set of protrusions includes an oval convex surface 1906 and a set of rails 1908 in the surface of second modular electronics device 1900. The set of protrusions are used to assist in the alignment of second modular electronics device 1900 to appropriately configured electronic devices. In other embodiments, instead of oval convex surface 1906 or set of rails 1908, second modular electronics device 1900 may include other convex or concave surfaces. In yet another embodiment, the set of protrusions does not exist, and only set of keying/alignment elements 1904 of top connector 1902 is used for alignment.

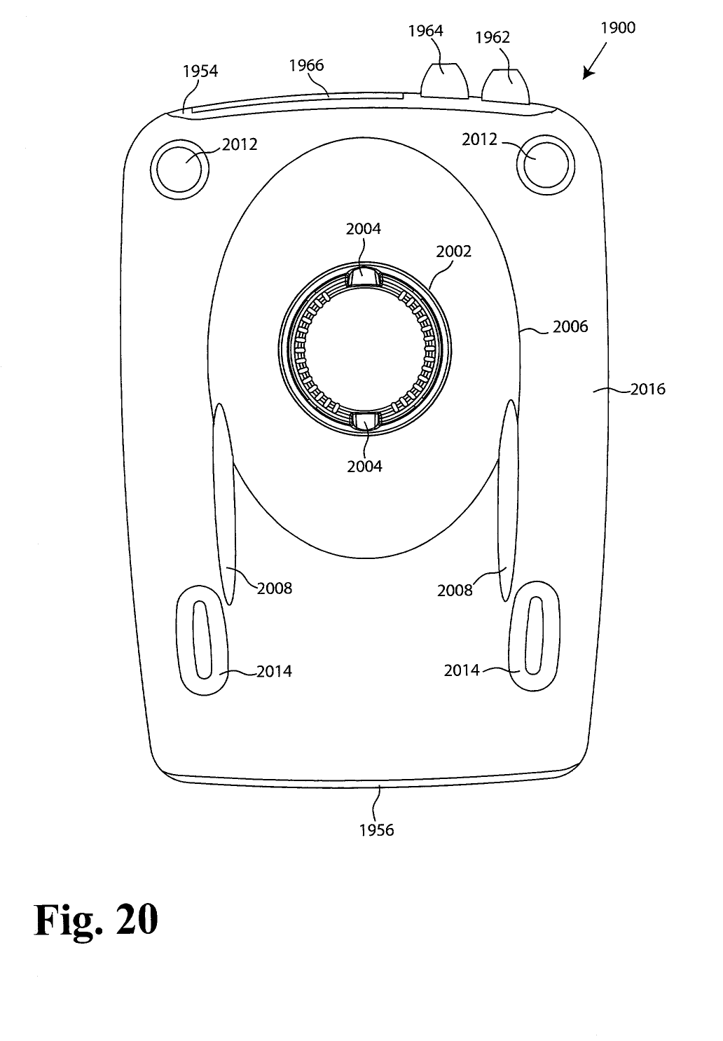

FIG. 20 is a bottom-up view of second modular electronics device 1900 showing a bottom surface 2016 with a bottom connector 2002 located thereon. As shown, bottom connector 2002 is a circular connector as substantially disclosed in the Circular Connector System. Bottom connector 2002 includes a set of keying/alignment elements 2004. Bottom surface 2016 also includes a set of front feet 2012 and a set of rear feet 2014. In addition, bottom surface 2016 includes an oval depression 2006 and a set of trenches 1608. Bottom surface 2016 also includes an oval concave surface 2006.

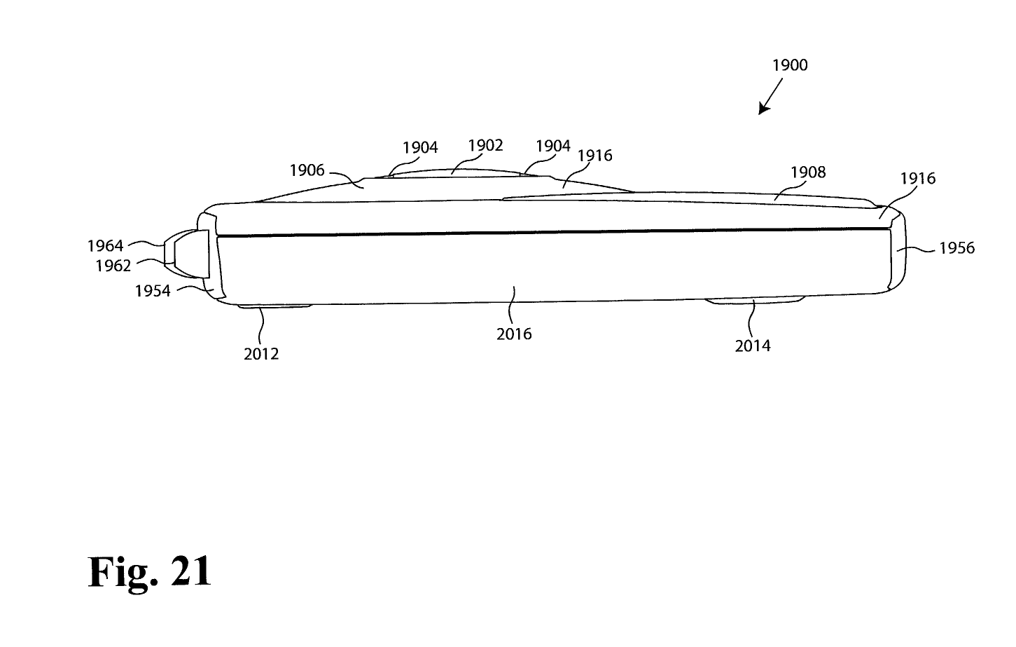

FIG. 21 is a side view of second modular electronics device 1900 illustrating the various vertical displacements of each of the elements on second modular electronics device 1900. In one embodiment, bottom surface 2016 is sloped upwards towards back surface 1956 and requires set of rear feet 2014 to be thicker (e.g., taller) than set of front feet 2012 such that top surface 1916 is of a certain horizontal orientation.

As previously discussed, it is desirable that each modular electronics device, no matter how it is shaped, should contain standoff and stacking features (e.g., feet) to allow sufficient vertical space between each of the devices or the device and the surface on which the device is resting. In addition, the size of the standoff features should be proportional to the height of the top connectors on the devices versus the recess of the bottom connectors on the devices. Referring to FIG. 21, in the current embodiment, bottom connector 2002 should not protrude below bottom surface of bottom surface 2016. In another embodiment, bottom connector 2002 can protrude below bottom surface of bottom surface 2016, but not below set of front feet 2012 and set of rear feet 2014. In this embodiment, bottom connector 2002 may touch the surface on which the device is resting, in which case a short-circuit is a more likely occurrence if the surface on which the device is resting (e.g., a table top) is either electrically conductive (e.g., metal) or has substances on top of which that are electrically conductive (e.g., liquids on table top, paperclips or screws,). The vertical position of bottom connector 2002 directly affects the vertical position of top connector.

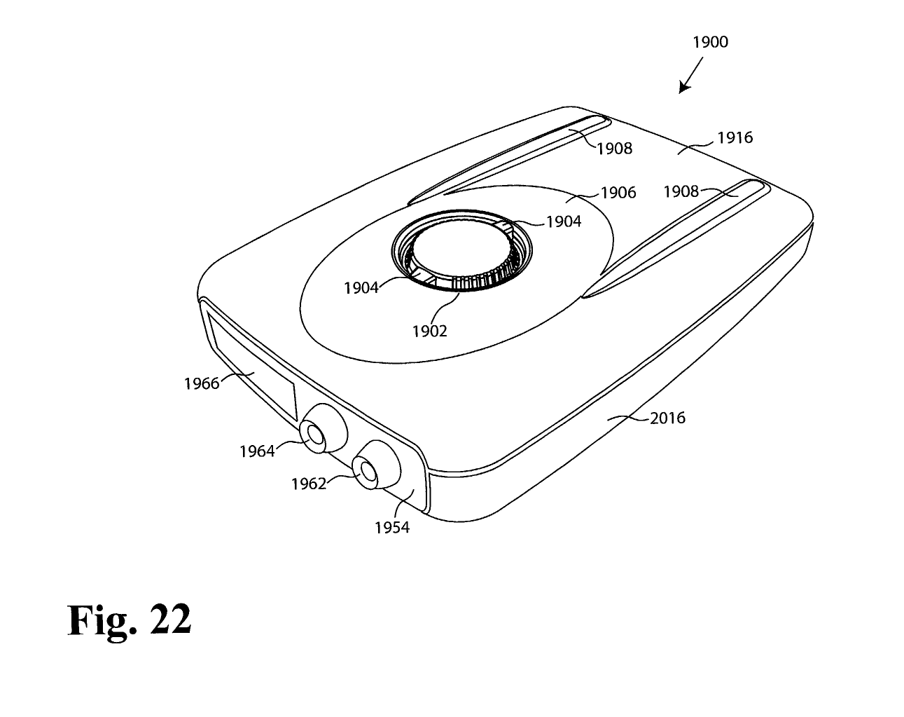

FIG. 22 is an orthogonal view of second modular electronics device 1900, where front surface 1954 and bottom surface 2016 is shown. Also shown in FIG. 22 is top connector 1902 with keying elements 1904, oval convex surface 1906, and top surface 1916 with set of rails 1908.

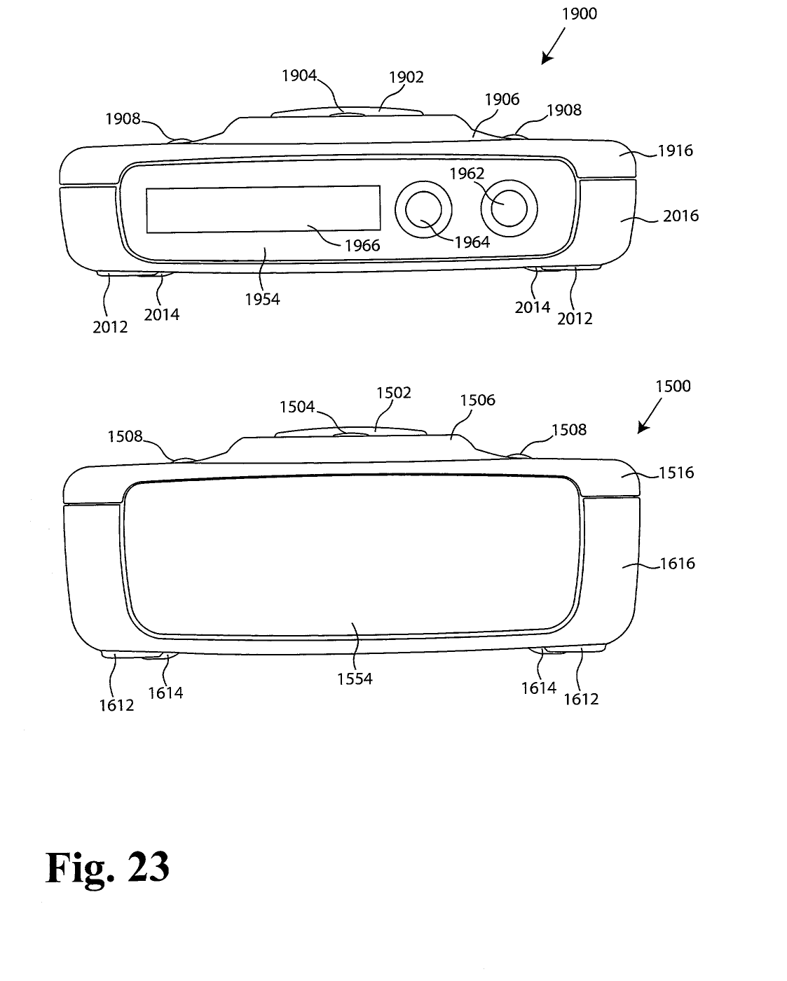

FIG. 23 is a front view of second modular device 1900 in position to be stacked on top of first modular device 1500. In one embodiment, all surface features on the bottom surface of each modular electronics device (e.g., bottom surface 1616) are substantially identical to each other. The surface features on these bottom surfaces mirror the surface features on the top surface of each modular electronics device and allow each device to be placed on top of any other device. For example, the surface features on bottom surface 2016 mirror the surface features on top surface 1516, allowing second modular electronics device 1900 to be stacked on top of first modular electronics device 1500.

Set of trenches 2008 is matched to set of rails 1508 so that when bottom surface 2016 is placed on top surface 1516, set of rear feet 2014, along with and set of trenches 2008, nestles with set of rails 1508. In one embodiment, the inside edge of each foot in the set of rear feet 2014 is on the outside edge of each rail in set of rails 1508. In another embodiment, the outside edge of each foot in the set of rear feet 2014 is on the inside edge of each rail in set of rails 1508. In addition, oval depression 2006 is matched to the shape of oval convex surface 1506 to assist in the alignment of the two devices. These surface elements, along with keying element 1504 on top connector 1502 of first modular electronics device 1500 and keying element 2004 on bottom connector 2002 of second modular electronics device 1900, assist both to align the devices during the stacking of the devices and to maintain the alignment of the devices when stacked. In one embodiment, the surface elements of bottom surface 2016 and top surface 1516 do not mechanically interlock with each other but are simply used for alignment and spacing purposes. The connectors are the interlocking elements that maintain, along with gravity, the connectivity between the devices.

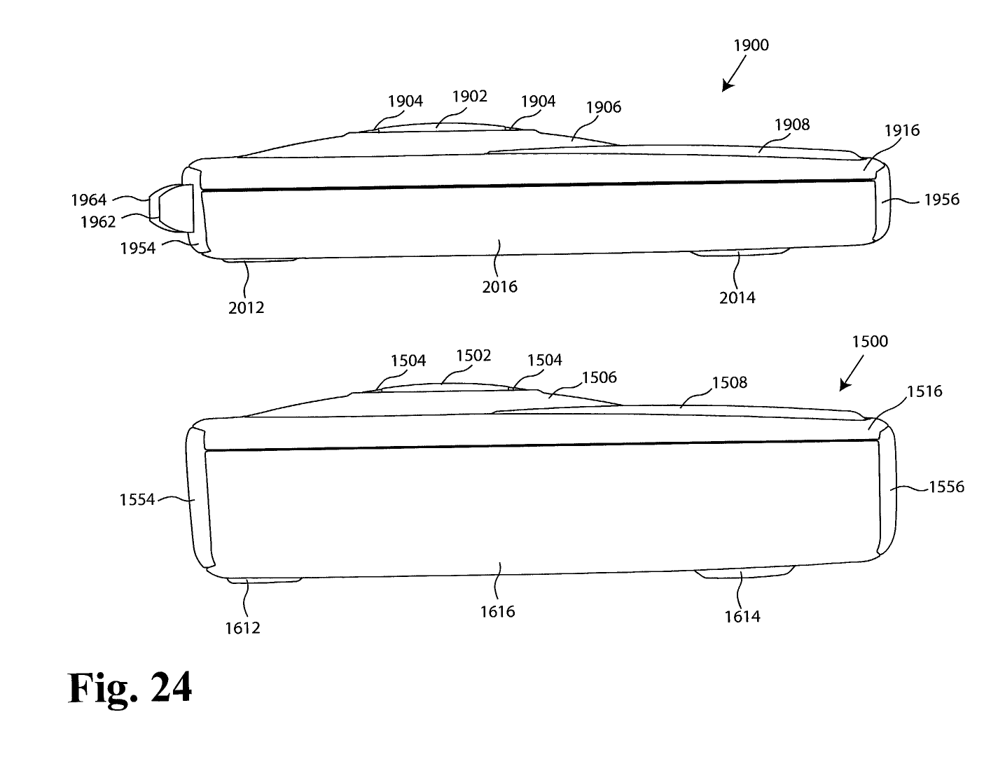

FIG. 24 is a side view of second modular electronics device 1900 in position to be stacked on top of first modular electronics device 1500. Set of front feet 2012 and set of rear feet 2014 are of a specific height to allow placement of second modular electronics device 1900 on top of top surface 1516 such that front surface 1954 of second modular device 1900 is substantially perpendicular with the surface on which first modular electronics device 1500 is resting once second modular electronics device 1900 is placed on first modular electronics device 1500.

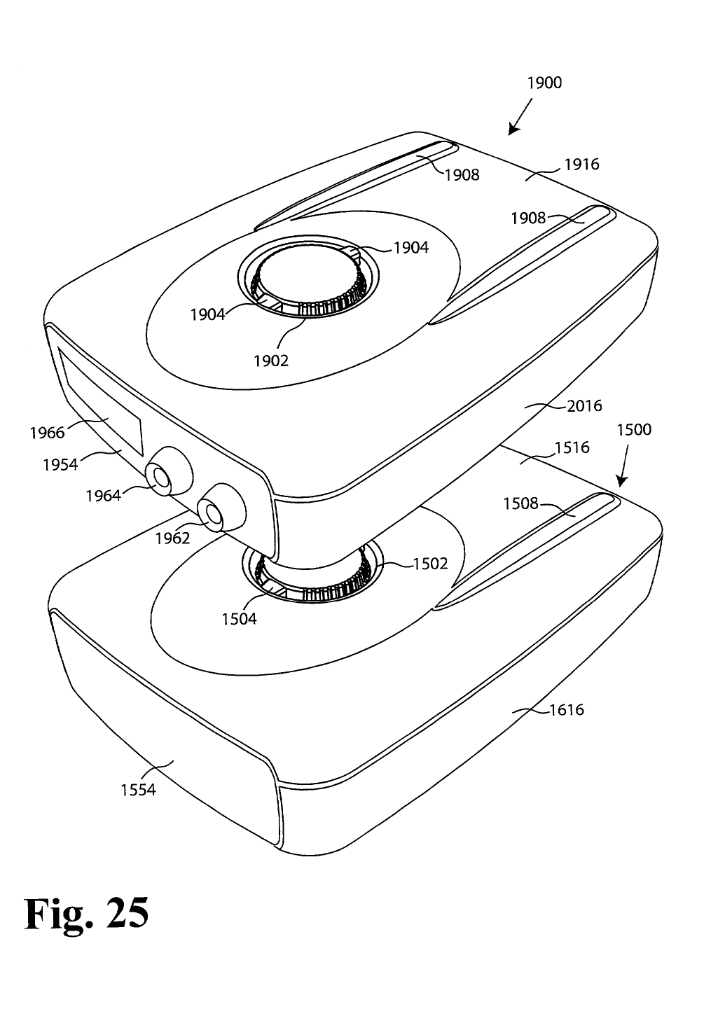

FIG. 25 is an orthogonal view of second modular electronics device 1900 in position to be stacked on top of first modular electronics device 1500. The stacking is performed with second modular electronics device 1900 being placed on top of first modular electronics device 1500, with bottom connector 2002 of second modular electronics device 1900 being placed in contact with top connector 1502 of first modular electronics device 1500.

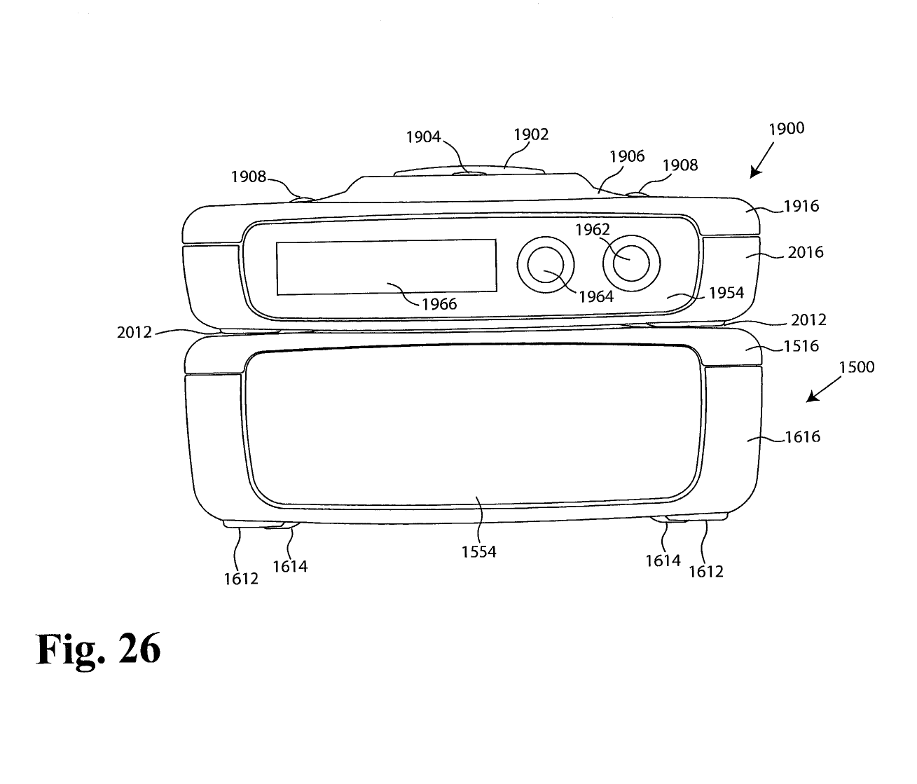

FIG. 26 is a front view of second modular electronics device 1900 stacked on top of first modular electronics device 1500.

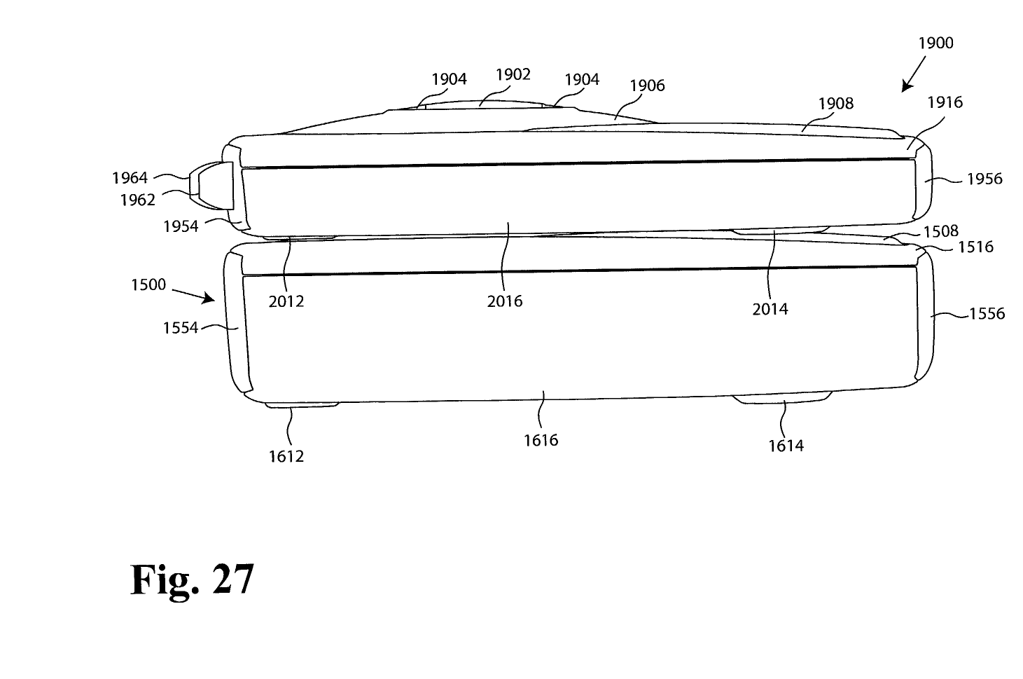

FIG. 27 is a side view of second modular electronics device 1900 stacked on top of first modular electronics device 1500.

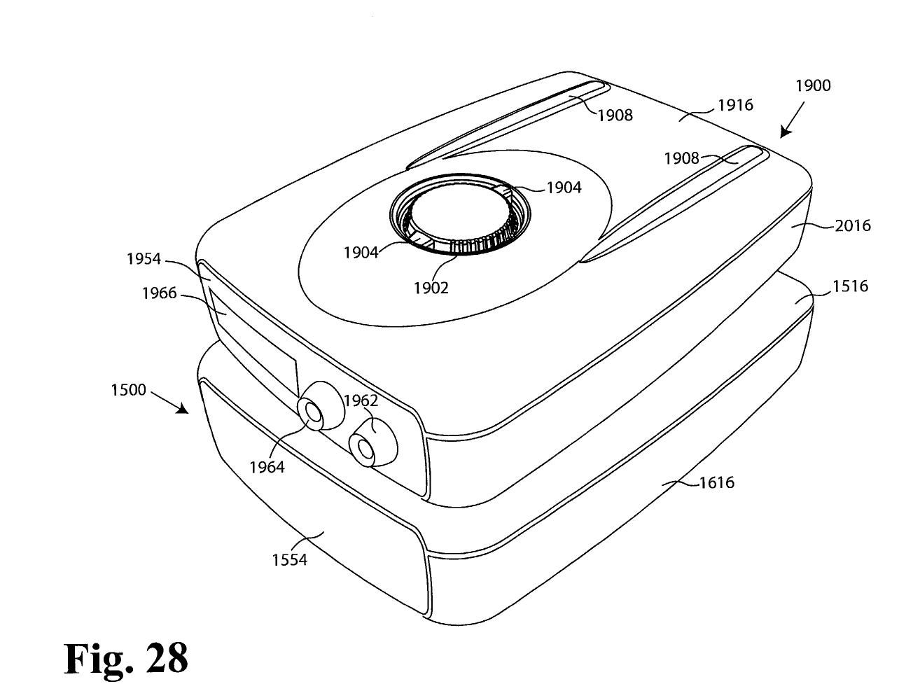

FIG. 28 is an orthogonal view of second modular electronics device 1900 stacked on top of first modular electronics device 1500.

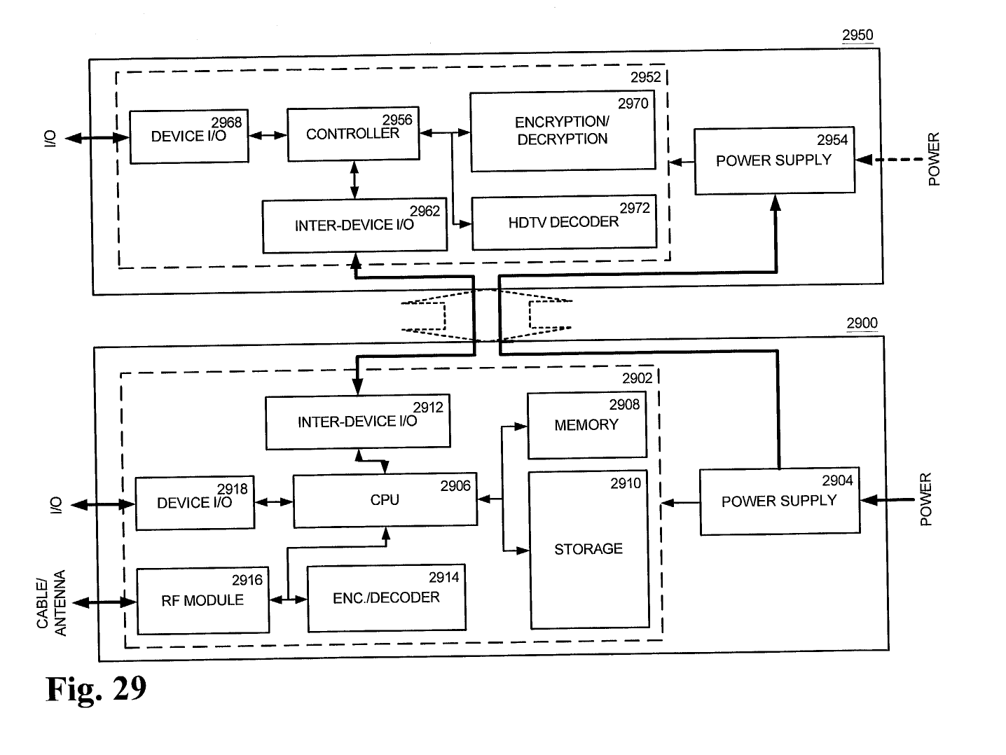

FIG. 29 is a block diagram for describing the functionality and interactivity between first electronics device 100 and second electronics 500. A set-top box 2900 represents first electronics device 100, and a signal decoder 2950 represents second electronics device 500. In one embodiment, set-top box 2900 includes a functional unit 2902 powered by a power supply 2904. Functional unit 2902 includes a central processing unit (CPU) 2906, a memory unit 2908, a storage device 2910, an inter-device input/output (I/O) unit 2912, an encoder/decoder unit 2914, a device (I/O) 2918, and a radio frequency (RF) module/tuner 2916.

CPU 2906 may be a general-purpose processor or an application specific integrated circuit (ASIC) configured to execute certain programming code or algorithms. In one embodiment, these program codes or algorithms are contained in one or more program files. The program code and algorithms provide such set-top box functionality as scheduled recording and/or tuning, updating and display of television channel/program guides, encryption and decryption of digital audio/video data, access and management of data files, and network connectivity. The program code and algorithm that provides all set-top box device features and operations is collectively referred to as an operating system. In one embodiment, CPU 3006 may be a processor from the x86 family of processors made by either Intel Corp. or Advanced Micro Devices, Inc.; or from the PowerPC family of processors available from Motorola Inc. or IBM Corp. In another embodiment, CPU 3006 may be a processor from the ARM family of processors as defined by ARM Holdings, plc (http://www.arm.com), and manufactured by such companies as Intel Corp. and Philips Corp. In general, the choice of the processor is left up to the implementer, with such factors as speed, power consumption, and programmability being taken into consideration.

CPU 2906 is coupled to RF module/tuner 2916, which provides tuning and reception of various radio frequencies, such as National Television Standards Committee (NTSC) signals, or frequency modulated (FM)/amplitude modulated (AM) radio signals. In one embodiment, RF module/tuner 2916 also provides transmission capability to transmit RF signals.

CPU 2906 is also coupled to encoder/decoder 2914, which receives signals from RF module 2916 to provide text, audio and video data decoding. Encoder/decoder 2914 also provide text, audio and video data encoding and sends signals to RF module 2916 for transmission. In one embodiment, encoder/decoder 2914 operates to encode or decode streams of analog signals to or from digital streams of information in accordance with the MPEG-2 standard. In another embodiment, encoder/decoder 2914 is also capable of MPEG-4 decoding and encoding. Encoder/decoder 2914 may also support the standard interface for cable modems, as defined in Data Over Cable Systems Interface Specifications (DOCSIS) by Cable Television Laboratories, Inc., found at http://www.cablelabs.com/.

CPU 2906 is coupled to and stores data in storage unit 2910. Storage unit 2910 includes one or more mass storage devices, such as a magnetic disk drive (e.g., hard drives), optical or magnetic-optical disk drives (e.g., compact-disc read-only memory/CD-ROM drives, CD re-writable/CD-RW drives, digital video disc ROM and RAM/DVD-ROM/RAM drives), removable magnetic media drives (e.g., floppy drives and tape drives) or even random access memory module (RAM) drives. CPU 2906 is also coupled to and stores data in memory 2908. Memory 2908 may be RAM modules such as Single In-line Memory Modules (SIMM), Dual In-line Memory Modules (DIMM), or Small Outline DIMM (SO-DIMM) containing Dynamic Random Access Memory (DRAM), Rambus DRAM (RDRAM) or Synchronous DRAM (SDRAM). Memory 2906 may also be non-volatile memory modules such as Read Only Memory (ROM) modules, Erasable Programmable ROMs (EPROM), or Flash Erasable Programmable ROMs (FEPROM) (e.g., Flash Memory).

For efficient use of data storage resources, the location of the storage of data is dependant on the type of data that is being stored. In one embodiment, audio and video digital data files, which typically are large, is stored on storage unit 2910. Storage unit 2910 can also store program files and executable computer code. Memory 2908 is used to hold data that is being processed by CPU 2906 or for temporary storage of data. In addition, in one embodiment, memory 2908 includes non-volatile memory to store program files for the operation of first electronics device 100 as a back-up to any portion of the program files stored in other parts of memory 2908 or storage unit 2910. Typically, as non-volatile memory is slower in access speed and has a limited amount of programmability (re-writability), volatile memory is used to store temporary or operating data. Thus, the program files that are used by CPU 2906 during normal operation would be stored in the volatile portion of memory 2908 with the non-volatile portion of memory 2908 being used for storing a backup of certain program files. In general, the allocation of data storage is dependent on the specific implementation.

CPU 2906 is also coupled to a device I/O 2918 for sending and receiving information to other devices. Device I/O 2918 includes such physical and communications input and output standards as standard audio/video (e.g., RCA) jacks, optical jacks, S-Video jacks, coaxial and RF jacks, Video Electronics Standards Association's (VESA) Super Video Graphics Array (SVGA) jacks, Electronics Industry Association (EIA)-232 (e.g., RS-232) Serial Interface ports, Universal Serial Bus (USB) ports, Institute of Electrical and Electronics Engineers (IEEE) 1394 (e.g., FireWire and I-Link) ports, and parallel (Centronics) ports. Device I/O 2918 may also include such local area and wide area network interfaces as IEEE 802.3 (Ethernet), IEEE 802.5 (Token Ring), Integrated Services Digital Network (ISDN), the various types of Digital Subscriber Lines (xDSL), and regular circuit switched analog phone (e.g., POTS). Device I/O 2918 also includes user interface devices such as display 404, and switch 110. These user interface devices allow the user to interact with and receive information from the first electronics device 110.

Inter-device I/O 2912 provides information transfer functionality between first electronics device 100 and second electronics device 2950. Inter-device I/O 2912 provides fault tolerant, hot-swappable, plug-and-play functionality between set-top box 2900 and another device that provides the same mechanical and electrical interface as inter-device I/O 2912. In addition inter-device 2912 provides automatic configuration and set-up for other devices on set-top box 2900 to add or replace functionality or enhancements of set-top box 2900. In one embodiment, inter-device I/O 2912 may be implemented with a standard such as the USB standard, the latest of which is the USB revision 2.0 specification, found at http://www.usb.org. In another embodiment, inter-device I/O 2912 may be a standard such as the IEEE-1394 (FireWire) standard, the latest of which may be found at http://www.ieee.org. It should be noted that certain connectors in device I/O 2918 may be used to connect to other devices in lieu of inter-device I/O 2912. However, these other connector systems typically do no offer an integrated signal and power connector system that is capable of transferring data signals as well as creating a power bus while providing mechanical interlocking between devices and eliminating the use of cables.

All signal and data lines of inter-device I/O 2912 is integrated into top connector 102 of first electronics device 100, which is a circular connector as disclosed in the Circular Connector System, above. In addition to including contacts for data transfer for inter-device I/O 2912, top connector 102 also includes contacts for power supplied by power supply 2904. Top connector 102 is mated to bottom connector 602 on second electronics device 500. Bottom connector 202 of first electronics device 100 also accesses inter-device I/O 2912. Thus, the circuitry of first electronics device 100 may be accessed through either top connector 102, bottom connector 202, or both. Inter-device I/O 2912 coordinates the signals received from/sent to top connector 102, bottom connector 202, and set-top box 2900.

Power supply 2904 provides the necessary power to functional unit 2902 in alternating current (AC) or direct current (DC) form. In one embodiment, power supply 2904 is a power conversion circuit that takes an AC power source and converts it into a DC power source for functional unit 2902. As illustrated in FIG. 29, power supply 2904 is logically included with set-top box 2900. However, physically, power supply 2904 does not have to be completely located within first electronics device 100. Thus, any part of the circuitry for power supply 2904 may be placed in a separate container such as a wall-mounted power adapter. The physical location of power supply 2904 is not critical and is dependent on the implementation. The functions of power supply 2904 are further described below during the description of power supply 2954.

Although set-top box 2900 (first electronics device 100) provides certain functionality, it may not, for whatever reason, contain all the functionality desired or required by a user. Thus, the user may wish to add additional capabilities to set-top box 2900. Continuing to refer to FIG. 29, signal decoder 2950 may be added to set-top box 2900 by coupling them together. Specifically, second electronics device 500 is placed on top of first electronics device 100 as described above, where bottom connector 602 of second electronics device 500 is coupled to top connector 102 of first electronics device 100 simply by the user placing second electronics device 500 on top of first electronics device 100. As described above, first electronics device 100 and second electronics device 500 are mechanically coupled to each other by top connector 102 and bottom connector 602, and spacing between the devices is maintained by set of feet 612. Alignment is achieved by use of set of top connector keying elements 104 and set of bottom connector keying elements 604. It should be apparent that first electronics device 100 may also be placed on top of second electronics device 500, with the interface between the two device being through top connector 502 of second electronics device 500 and bottom connector 202 of first electronics device 100.

Signal decoder 2950 includes an inter-device I/O 2962 that communicates with inter-device 2912. In one embodiment, inter-device I/O 2962 is identical in function to inter-device I/O 2912, which has been described above. Thus, the signals and data lines of inter-device I/O 2962, along with the power lines from a power supply 2954, is also routed to the circular connectors. Specifically, the physical inputs and outputs of inter-device I/O 2962 and power supply 2954 are routed to bottom connector 602. In addition, the signals are routed to top connector 502.

Power supply 2954 is used to power signal decoder 2952. As described above for power supply 2904, power supply 2954 may utilize AC power source such as the power supplied by common power outlets. However, both power supply 2954 and power supply 2904 may use the power lines from the top or bottom connectors and thus do not have to be plugged in to a power outlet. For example, when second electronics device 500 is coupled to first electronics device 100 through the use of the circular connectors, power supply 2954 may utilize the power supplied by power supply 2904 and does not to be connected to a power outlet. In another embodiment, power supply 2954 intelligently switches between the power provided by power supply 2904 and an external power source (e.g., a power outlet), depending on whether power supply 2054 detects power from power supply 2904. In another embodiment, power supply 2954 detects whether the user has plugged in a power cord (not shown) and uses the external power source if the user has plugged in the power cord. Power supply 2904 may supply power to power supply 2954 in a variety of voltages. In one embodiment, power supply 2904 simply provides power supply 2954 a connection to the power received from the wall outlet (e.g., a standard AC power source). In another embodiment, power supply 2904 provides conversion of the power received from the wall outlet before it is accessed by power supply 2954. For example, power supply 2904 may convert the 120-volt, 60-hertz AC power received from a standard United States wall power jack to a 5-volt, DC power source that is supplied on top connector 102 and bottom connector 202. Moreover, the converted power from power supply 2904 may or may not be the same form as is sent to functional unit 2902. Thus, functional unit 2902 may have a different voltage type and magnitude requirement than power supply 2954.

Power supply 2954 supplies power to a functional unit 2952, which includes a device I/O 2968, a controller 2956, an encryption/decryption unit 2970, inter-device I/O 2962, and an HDTV decoder 2972. Controller 2956 controls the operation of all the circuitry in functional unit 2952. In one embodiment, controller 2956 is a microcontroller that can execute computer readable code or program files. In another embodiment, controller 2956 is an ASIC that is pre-programmed with instructions to operate signal decoder 2950.

Encryption/decryption unit 2970 provides encryption and decryption of cryptographic data. Formats supported include such standards as the ANSI standard Data Encryption Algorithm (DEA) defined in ANSI X3.92-1981, Public-Key Encryption (PKE) implemented in the RSA algorithm as invented by Ron Rivest, Adi Shamir, and Leonard Adleman in 1977, or the Digital Signature Standard (DSS) as defined by the National Institute of Standards and Technology (NIST) in Federal Information Processing Standard (FIPS) 186-2, effective Jun. 27, 2000. In addition, encryption/decryption unit 2970 may also implement the guidelines and specifications promulgated by the Secure Digital Music Initiative (SDMI), locatable at http://www.sdmi.org.

HDTV decoder 2972 decodes HDTV signals received from device I/O 2968 or inter-device I/O 2962. In one embodiment, first electronics device 100 receives audio and video signals from an external source such as an antenna or coaxial cable, then passes those signals to second electronics device 500, which uses encryption/decryption unit 2970 along with HDTV decoder 2972 to extract and process all digital television (including HDTV and standard digital television) signals. These processed signals are returned to be further processed for display by first electronics device 100.

First electronics device 100 may also send signals to second electronics device 500 to encode for sending to other devices or destinations. In one embodiment, first electronics device 100 sends second electronics device 500 the signals to be encoded through the use of inter-device I/O 2912 and inter-device I/O 2962, along with the requested encryption type. Then, second electronics device 500 encodes the signals and returns them back to first electronics device 100 through inter-device I/O 2962 and inter-device I/O 2912. First electronics device 100 then may output those signals through device I/O 2918, RF module 2916, or to another stacked device on bottom connector 202 or top connector 102 (passing through second electronics device 500).

Controller 2956 is coupled to device I/O 2968 for communicating with other devices and information sources. In one embodiment, device I/O 2968 may have the same interfaces as device I/O 2918. This allows second electronics device 500 to be used in a stand-alone mode with non-stackable devices. In another embodiment, device I/O 2968 may have a limited set of outputs, with the majority of functionality only accessible through inter-device I/O 2962 and thus only through stackable devices as described herein.

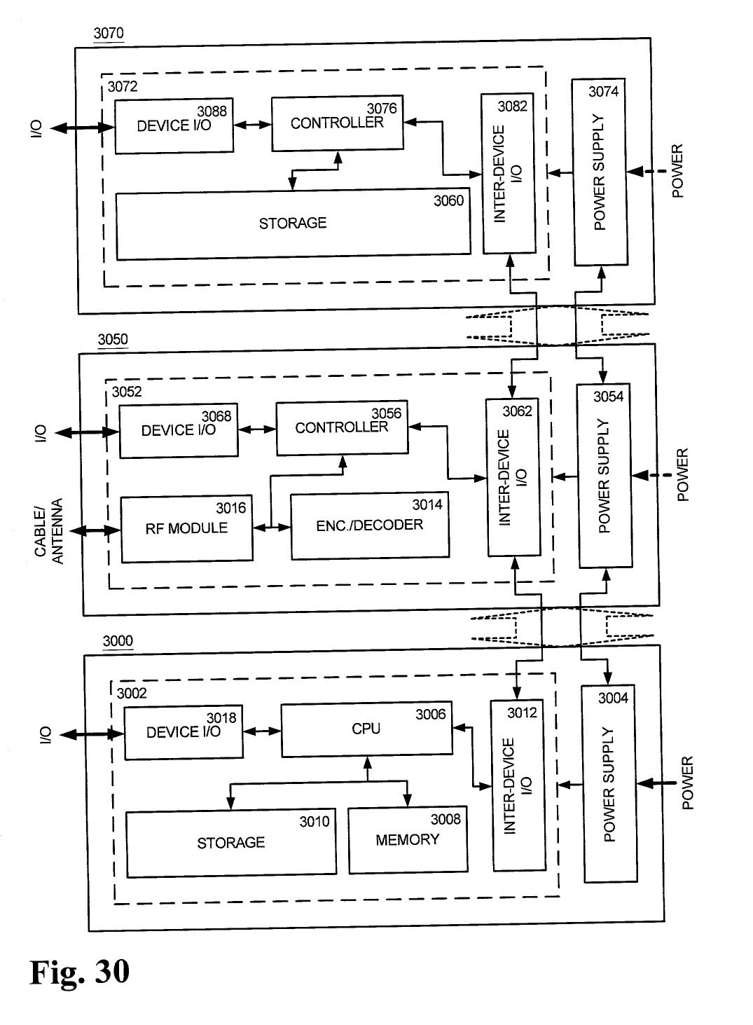

FIG. 30 is a block diagram for describing the functionality and interactivity between first modular electronics device 1500 and second modular electronics device 1600. A computer system 3000 represents first modular electronics device 1500, and a signal decoder 3050 represents second modular electronics device 1900. FIG. 30 also contains a storage expansion device 3070, representing a third modular electronics device (not shown).

In one embodiment, computer system 3000 includes a functional unit 3002 powered by a power supply 3004. Functional unit 3002 includes a central processing unit (CPU) 3006, a memory unit 3008, a storage device 3010, an inter-device input/output (I/O) unit 3012 and a device (I/O) unit 3018. The parts of computer system 3000 together provide a general-purpose computer system, which may run such general-purpose operating systems as Microsoft Windows, Apple Mac OS, Linux, or Unix. In another embodiment, computer system 3000 may also use other implementation specific operating systems as Wind River VxWorks, QNX Software Systems Real-Time Operating System (RTOS), or Microware OS-9.

CPU 3006 may be a general-purpose processor or an application specific integrated circuit (ASIC) configured to execute certain programming code or algorithms. In one embodiment, these program codes or algorithms are contained in one or more program files. The program code and algorithms provide such general-purpose computer system functionality as access and management of data files, network connectivity, word processing, graphics processing, spreadsheet, e-mail, and “browsing” of the World Wide Web. The program code and algorithm that provides all computer system features and operations is collectively referred to as an operating system and applications. In one embodiment, CPU 3006 may be a processor from the x86 family of processors made by either Intel Corp. or Advanced Micro Devices, Inc.; or from the PowerPC family of processors available from Motorola Inc. or IBM Corp. In another embodiment, CPU 3006 may be a processor from the ARM family of processors as defined by ARM Holdings, plc (http://www.arm.com), and manufactured by such companies as Intel Corp. and Philips Corp. In general, the choice of the specific processor is up to the implementer, with such factors as speed, power consumption, and programmability being taken into consideration.

CPU 3006 is coupled to and stores data in storage unit 3010. Storage unit 3010 is one or more mass storage devices, such as a magnetic disk drive including but not limited to hard drives, optical or magnetic-optical disk drives including but limited to compact-disc read-only memory (CD-ROM) drives, CD re-writable (CD-RW) drives, digital video disc ROM and RAM (DVD-ROM/RAM drives), floppy drives or even random access memory module (RAM) drives. CPU 3006 is also coupled to and stores data in memory 3008. Memory 3008 may be RAM modules such as Single In-line Memory Modules (SIMM), Dual In-line Memory Modules (DIMM), or Small Outline DIMM (SO-DIMM) containing Dynamic Random Access Memory (DRAM), Rambus DRAM (RDRAM) or Synchronous DRAM (SDRAM). Memory 3006 may also be non-volatile memory modules such as Read Only Memory (ROM) modules, Erasable Programmable ROMs (EPROM), or Flash Erasable Programmable ROMs (FEPROM) (e.g., Flash Memory).

For efficient use of data storage resources, the location of the storage of data is dependant on the type of data that is being stored. In one embodiment, audio and video digital data files, which typically are large, is stored on storage unit 3010. Storage unit 3010 can also store program files and executable computer code. Memory 3008 is used to hold data that is being processed by CPU 3006 or for temporary storage of data. In addition, in one embodiment, memory 3008 includes non-volatile memory to store program files for the operation of first modular electronics device 1500 as a back-up to any portion of the program files stored in other parts of memory 3008 or storage unit 3010. Typically, as non-volatile memory is slower in access speed and has a limited amount of programmability (re-writability), volatile memory is used to store temporary or operating data. Thus, the program files that are used by CPU 3006 during normal operation would be stored in the volatile portion of memory 3008 with the non-volatile portion of memory 3008 being used for storing a backup of certain program files. In general, the allocation of data storage is dependent on the specific implementation.

CPU 3006 is also coupled to a device I/O 3018 for sending and receiving information to other devices. Device I/O 3018 includes such physical and communications input and output standards as standard audio/video (e.g., RCA) jacks, optical jacks, S-Video jacks, coaxial and RF jacks, Video Electronics Standards Association's (VESA) Super Video Graphics Array (SVGA) jacks, Electronics Industry Association (EIA)-232 (e.g., RS-232) Serial Interface ports, Universal Serial Bus (USB) ports, Institute of Electrical and Electronics Engineers (IEEE) 1394 (e.g., FireWire and I-Link) ports, IBM PS/2 ports and parallel (Centronics) ports. Device I/O 3018 may also include such local area and wide area network interfaces as IEEE 802.3 (Ethernet), IEEE 802.5 (Token Ring), Integrated Services Digital Network (ISDN), the various types of Digital Subscriber Lines (xDSL), and regular circuit switched analog phone (e.g., POTS).

Inter-Device I/O 3012 provides information transfer functionality between first modular electronics device 1500 and second electronics device 3050. Inter-device I/O 3012 provides fault tolerant, hot-swappable, plug-and-play functionality between computer system 3000 and another device that provides the same mechanical and electrical interface as inter-device I/O 3012. In addition inter-device 3012 provides automatic configuration and set-up for other devices on computer system 3000 to add or replace functionality or enhancements of computer system 3000. In one embodiment, inter-device I/O 3012 may be implemented with a standard such as the USB standard, the latest of which is the USB revision 2.0 specification, found at http://www.usb.org. In another embodiment, inter-device I/O 3012 may be a standard such as the IEEE-1394 (FireWire) standard, the latest of which may be found at http://www.ieee.org. In yet another embodiment, a network standard such as Ethernet may be used. In still yet another embodiment, a mixed multiple channel architecture of USB, FireWire, Ethernet and/or other communication protocols may be used. For example, USB allows the connectivity of up to 127 devices in a tiered star topology. Due to timing considerations, up to seven tiers allowed. If USB is used as the bus protocol for the inter-device I/O units, a maximum of five devices may be stacked if each device includes a function and a hub (e.g., a compound device, which is a combination of a hub and a function). If each device is directly connected to a hub, then up to six devices, or functions, may be stacked. In order to increase the number of devices that may be stacked, separate channels in the circular connector may be used. In one embodiment, each channel is for a separate USB port off of a hub or a root hub. Compound devices may then be used, where each device includes a hub that has at least one downstream port available to another stacking device. In this way, the stack architecture can increase by five devices for every channel that can be added in the connector system.

All signal and data lines of inter-device I/O 3012 is integrated into top connector 1502 of first modular electronics device 1500, which is a circular connector as disclosed in the Circular Connector System, above. In addition to including contacts for data transfer for inter-device I/O 3012, top connector 1502 also includes contacts for power supplied by power supply 3004. Top connector 1502 is mated to bottom connector 2002 on second modular electronics device 1900. Bottom connector 1602 of first modular electronics device 1500 also accesses inter-device I/O 3012. Thus, the circuitry of first modular electronics device 1500 may be accessed through either top connector 1502, bottom connector 1602, or both. Inter-device I/O 3012 coordinates the signals received from/sent to top connector 1502, bottom connector 1602, and computer system 3000.

Power supply 3004 provides the necessary power to functional unit 3002 in alternating current (AC) or direct current (DC) form. In one embodiment, power supply 3004 is a power conversion circuit that takes an AC power source and converts it into a DC power source for functional unit 3002. As illustrated in FIG. 30, power supply 3004 is logically included with computer system 3000. However, physically, power supply 3004 does not have to be physically located within first modular electronics device 1500. Thus, any part of the circuitry for power supply 3004 may be placed in a separate container such as a wall-mounted power adapter. The physical location of power supply 3004 is not critical and is dependent on the implementation. The functions of power supply 3004 are further described below during the description of power supply 3054.

Although computer system 3000 (first modular electronics device 1500) provides certain functionality, it may not, for whatever reason, contain all the functionality desired or required by a user. Thus, the user may wish to add additional capabilities to computer system 3000. Continuing to refer to FIG. 30, signal decoder 3050 may be added to computer system 3000 by coupling them together. Specifically, second modular electronics device 1900 is placed on top of first modular electronics device 1500 as described above, where bottom connector 2002 of second modular electronics device 1900 is coupled to top connector 1502 of first modular electronics device 1500 simply by the user placing second modular electronics device 1900 on top of first modular electronics device 1500. As described above, first modular electronics device 1500 and second modular electronics device 1900 are mechanically coupled to each other by top connector 1502 and bottom connector 2002. Alignment is achieved by use of set of top connector keying elements 1504 and set of bottom connector keying elements 2004. In addition, the alignment and spacing between the devices is maintained by the interaction between the surface elements of bottom surface 2016 of second modular electronics device 1900 and the surface elements of top surface 1516 of first modular electronics device 1500. Specifically, oval depression 2006 engages oval concave surface 1506; set of front feet 2012 rests on top surface 1516; and set of trenches 2008 and set of rear feet 2014 nestles with set of rails 1508, with set of rear feet 2014 gripping set of rails 1508 as described herein.

Signal decoder 3050 includes an inter-device I/O 3062 that communicates with inter-device 3012. In one embodiment, inter-device I/O 3062 is identical in function to inter-device I/O 3012, which has been described above. Thus, the signals and data lines of inter-device I/O 3062, along with the power lines from a power supply 3054, are also routed to the circular connectors. Specifically, the physical inputs and outputs of inter-device I/O 3062 and power supply 3054 are routed to bottom connector 2002. These signal and power lines are also routed to top connector 1902.

Power supply 3054 is used to power signal decoder 3052. As described above for power supply 2904, 2954, and 3004, power supply 3054 may utilize AC power source such as the power supplied by common household electricity jacks. However, both power supply 3054 and power supply 3004 may use the power lines from the top or bottom connectors and thus do not have to be plugged in to a power outlet. For example, when second modular electronics device 1900 is coupled to first modular electronics device 1500 through the use of the circular connectors, power supply 3054 may utilize the power supplied by power supply 3004 and does not need to be connected to a power outlet. In another embodiment, power supply 3054 intelligently switches between the power provided by power supply 3004 and an external power source (e.g., a power outlet), depending on whether power supply 2054 detects power from power supply 3004. In another embodiment, power supply 3054 detects whether the user has plugged in a power cord (not shown) and uses the external power source if the user has plugged in the power cord.

Power supply 3054 supplies power to a functional unit 3052, which includes a device I/O 3068, a controller 3056, inter-device I/O 3062, an encoder/decoder 3014, and an RF module 3016. Controller 3056 controls the operation of all the circuitry in functional unit 3052. In one embodiment, controller 3056 is a microcontroller that can execute computer readable code or program files. Typically, microcontroller have both a processor and built in memory, both volatile and non-volatile for storing program and data files. In another embodiment, controller 3056 is an ASIC that is pre-programmed with instructions to operate signal decoder 3050. Controller 3056 provides control of all functionality for second modular electronics device 1900.

Controller 3056 is coupled to RF module/tuner 3016, which provides tuning and reception of various radio frequencies, such as NTSC or HDTV signals, or frequency modulated (FM)/amplitude modulated (AM) radio signals. In one embodiment, RF module/tuner 3016 also provides transmission capability to transmit RF signals.

Controller 3056 is also coupled to encoder/decoder 3014, which receives signals from RF module 3016 to provide text, audio and video data decoding. Encoder/decoder 3014 also provide text, audio and video data encoding and sends signals to RF module 3016 for transmission. In one embodiment, encoder/decoder 3014 operates to encode or decode streams of analog signals to or from digital streams of information in accordance with the MPEG-2 standard. In another embodiment, encoder/decoder 3014 is also capable of MPEG-4 decoding and encoding. Encoder/decoder 3014 may also support the standard interface for cable modems, as defined in DOCSIS.

In one embodiment, second modular electronics device 1900 receives analog audio and video signals such as NTSC television signals on RF module 3016 and converts them using encoder/decoder 3014 into a digital format. This data is then transferred to first modular electronics device 1500 for either display or storage. First modular electronics device 1500 may control the tuning of RF module 3016 for specific frequencies based on certain events, such as a specified schedule or the match of a show on a television programming schedule.

First modular electronics device 1500 may also retrieve digital audio and video data from a source such as a data file stored on storage device 3010 or memory 3008, or another device connected to device I/O 3018 or inter-device I/O 3012, then pass that data to second modular electronics device 1900. Second modular electronics device 1900 then uses encoder/decoder 3014 to process this data to generate signals that are returned to first modular electronics device 1500 to be further processed for display.

First modular electronics device 1500 may also send signals to second modular electronics device 1900 to encode for sending to other devices or destinations. In one embodiment, first modular electronics device 1500 sends second modular electronics device 1900 the signals to be encoded through the use of inter-device I/O 3012 and inter-device I/O 3062, along with the requested encryption type. Then, second modular electronics device 1900 encodes the signals and returns them back to first modular electronics device 1500 through inter-device I/O 3062 and inter-device I/O 3012. First modular electronics device 1500 then may output those signals through device I/O 3018, or to another stacked device on bottom connector 1602 or top connector 1502 (passing through second modular electronics device 1900).

Controller 3056 is coupled to device I/O 3068 for communicating with other devices and information sources. In one embodiment, device I/O 3068 has the same interfaces as device I/O 3018. This allows second modular electronics device 1900 to be used in a stand-alone mode with non-stackable devices. Second modular electronics device 1900 may be controlled by a user through first control 1962 and second control 1964, with visual feedback and display to a user through a display 1966 In another embodiment, device I/O 3068 may have a limited set of outputs, with the majority of functionality only accessible through inter-device I/O 3062 and thus only through stackable devices as described herein. For example, although device I/O 3068 may include a FireWire or USB compatible ports, second modular electronics device 1900 do not provide the full set of functionality when accessed through these ports versus when the device is accessed through inter-device I/O 3062. In addition, all operations and features of second modular electronics device 1900 may be fully controllable through software.

In addition to providing new features to first modular electronics device 1500, existing features of first modular electronics device 1500 may also be supplemented or expanded. Continuing to FIG. 30, the user may add third modular electronics device, which is represented by storage expansion device 3070, to first modular electronics device 1500 to increase the amount of storage available to store data and program files.

In one embodiment, third modular electronics device has substantially identical physical top surface and bottom surface features (including the same inter-device—both top and bottom—connectors) as first modular electronics device 1500 and second modular electronics device 1900. In another embodiment, the third modular electronics device does not have the same physical top and bottom surfaces, but has a physical configuration that is geometrically compatible with stacking on top of or below first modular electronics device 1500 and/or second modular electronics device 1900. For example, the third modular electronics device may have a set of trenches on its bottom surface similar to set of trenches 1608 on bottom surface 1616 of first modular electronics device 1500 or set of trenches 2008 on bottom surface 2016 of second modular electronics device 1900, but significantly longer such that the set of rails on the bottom of third modular electronics device extends the whole length of set of rails 1508 on top surface 1516 of first modular electronics device 1500 or set of rails 1908 on top surface 1916 of second modular electronics device 1900. In another example, the third modular electronics device may have two pairs of rear feet; each pair of rear feet straddling one rail in the set of rails 1508 of first modular electronics device 1500 (or set of rails 1908) when the third modular electronics device is stacked on top of first modular electronics device 1500 (or second modular electronics device 1900).

With a physical configuration compatible for stacking with any modular electronics devices, third modular electronics device may be placed, or stacked, on top of second modular electronics device 1900 in the same fashion that second modular electronics device 1900 is stacked on first modular electronics device 1500. Specifically, the bottom surface of third modular electronics device is configured to stack on top of second modular electronics device 1900, with a circular bottom connector mated for connecting to top connector 1902 of second electronics device 1900.

In one embodiment, storage expansion device 3070 includes a functional unit 3072 powered by a power supply 3074. Power supply 3074 is, in one embodiment, identical to power supply 3004 and power supply 3054. Thus, power supply 3074 may draw on power supplied from a standard wall power jack or from the top connector or bottom connector of the third modular electronics device (not shown).

The power supplies described herein do not necessarily have to output the same total power (e.g., wattage) as each other. Thus, power supply 2904 and power supply 3004 may have a larger amount of wattage rating as power supply 2954, power supply 3054, or power supply 3074. In one embodiment, all power supply circuitry other than the source switching circuitry (e.g., the circuitry for determining which source of power from which the power supply is drawing) is contained in a separate enclosure (e.g., an external enclosure). This enclosure, also referred to as a power adapter (e.g., a wall mounted power supply), is interchangeable between the devices, with the only limitation on its use being that it should be able to provide enough power to all the devices in the stack that are not going to have another source of power. In other embodiments, all power supply circuitries may contribute to the total power supplied.

Functional unit 3072 includes a controller 3076, a device I/O 3088, a storage unit 3060, and an inter-device I/O 3082. Controller 3076 is a microcontroller that includes access and control functionality for storage unit 3060 to allow writing and reading data to and from of storage unit 3060 through device I/O 3088 and inter-device I/O 3082. Inter-device 3082 is identical in function to inter-device I/O 3012 and Inter-device I/O 3062, which have been described above. Thus, the third modular electronics device has a top connector and a bottom connector, which are identical to top connector 1502 and bottom connector 1602, respectively, of first modular electronics device 1500.

Controller 3076 is also coupled to device I/O 3088 for communicating with other devices. In one embodiment, device I/O 3088 includes an USB, a FireWire, and/or a Small Computer Systems Interface (SCSI) interface as defined in the SCSI family of standards found at the American Nation Standards Institute (ANSI), http://www.ansi.org. In another embodiment, device I/O 3088 may contain addition interfaces as identified above for device I/O 3012.

Controller 3076 is coupled to storage unit 3060 to control the storage and retrieval of program and data files. In one embodiment, storage unit 3060 includes one or more mass storage devices of the types identified above for storage unit 2910, including CD-ROM/R/RW drives, hard drives, DVD-ROM/R/RAM drives, or removable magnetic media drives. For example, storage unit 3060 may include a hard disk and a CD-RW drive that may be used independently or simultaneously.

As described above, third modular electronics device adds additional storage capacity to first modular electronics device 1500. In another embodiment, third modular electronics device may be used with second modular electronics device 1900 without fist modular electronics device 1500, with second modular electronics device 1900 storing and retrieving information, including digital and audio data, from third modular electronics device.

Although storage expansion device 3070 is shown to be above signal decoder 3050 in FIG. 30, the actual physical placement of the third modular electronics device does not necessarily have to be on top of second modular electronics device 1900. For example, the third modular electronics device may be stacked on top of first modular electronics device 1500, and the second modular electronics device 1900 stacked on top of third modular electronics device. Thus, any permutations of the different stacking configurations with the three devices may be possible, as all devices have a top connector and a bottom connector. In other embodiments, one of the devices may only have a top connector, and another device may only have a bottom connector, in which case, the placement of these devices may only be on the bottom and the top, respectively.

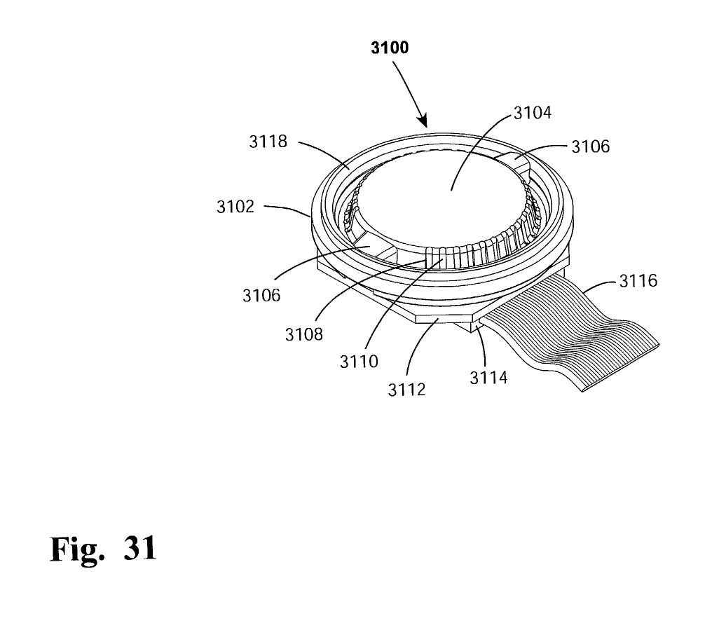

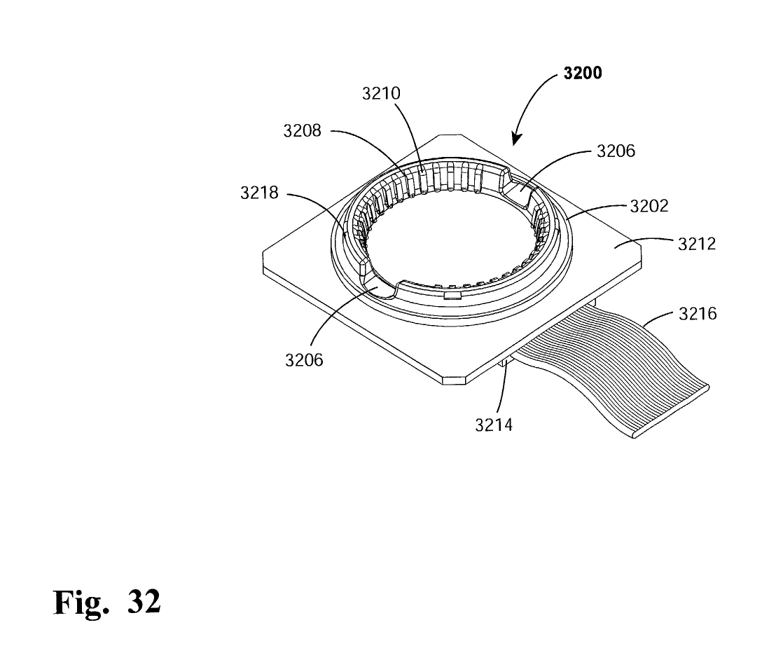

FIG. 31 is an isometric view of a plug connector 3100 configured in accordance with one embodiment of the present invention, including a circular housing 3102 configured to mate with a receptacle connector 3200 as shown in FIG. 32. Housing 3102 contains an integrated keying/alignment element 3106 and a set of openings 3108 displaced around a center portion 3104. A set of contacts 3110 is accessible through set of openings 3108. In another embodiment, set of contacts 3110 includes additional contacts accessible through a second set of openings displaced on an outer perimeter 3118. In yet another embodiment, set of openings 3108, instead of being displaced around center portion 3104, is only displaced around outer perimeter 3118.

As shown in FIG. 31, a ribbon cable 3116 is connected to plug 3114 to access a set of traces (not shown) in circuit board 3112. Plug 3114 is attached to a set of pins (not shown) on circuit board 3112. Through ribbon cable 3116, plug connector 3100 can connect to another circuit board (not shown) or other components. In another embodiment, the set of traces in circuit board 3112 may be accessed through a set of contact surfaces on top of circuit board 3112.

Housing 3102 may be made of any single type of or composite material such that the material surrounding set of openings 3108 is not conductive to electricity. In one embodiment, housing 3102 is made of a plastic material, such as Acrylonitrile-Butadiene-Styrene (ABS). In another embodiment, housing 3102 may be made out of a clear plastic material. In yet another embodiment, housing 3102 may be made out of a combination of plastic and metal materials, where portions of housing 3102 may use metal to allow housing 3102 to act as a conductor (e.g., for signal or for grounding), or as shielding. Again, the material used surrounding set of openings 3108 is preferably not electrically conductive. In contrast, set of contacts 3110 may be constructed using any conductive material. In one embodiment, set of contacts 3110 may be constructed using gold. In another embodiment, set of contacts 3110 may be constructed using copper. The choice of materials for housing 3102, and set of contacts 3110 is dependent on the application for the connector system.

FIG. 32 is an isometric view of a receptacle connector 3200. Receptacle connector 3200 includes a circular housing 3202 that has a keying/alignment element 3206 and a set of openings 3208. A set of contacts 3210 protrudes from set of openings 3208. In another embodiment, set of openings 3208 may include a set of openings located on an outer perimeter 3218. In this embodiment, set of contacts 3210 includes a set of contacts that are accessible through the set of openings on outer perimeter 3218. In yet another embodiment, set of openings 3208 are located on outer perimeter 3218. Set of contacts 3210 is mounted to a circuit board 3212 through a set of circuit board contacts 3508 on circuit board 3212 (not shown). Circuit board 3212 is connected to a plug 3214 that is on a ribbon cable 3216. The above description of the materials used in the construction of plug connector 3100 applies equally to receptacle connector 3200.

The choices of which type of connectors (e.g., plug connector 3100 and receptacle connector 3200), as top connectors and bottom connectors in the modular electronic devices described herein are flexible and implementation specific. In one embodiment, top connector 102 of first electronics device 100, top connector 502 of second electronics device 500, top connector 1502 of first modular electronics device 1500 and top connector 1902 of second modular electronics device 1900 are of the plug connector type as described for plug connector 3100. In addition, bottom connector 202 of first electronics device 200, bottom connector 602 of second electronics device 500, bottom connector 1602 of first modular electronics device 1500 and bottom connector 2002 of second modular electronics device 1900 are of the receptacle connector type as described for receptacle connector 3200. In another embodiment, top connectors are of the receptacle connector type as described for receptacle connector 3200 and bottom connectors are of the plug connector type as described for plug connector 3100. In other embodiments, other types of plugs and connectors that conform to the keying and spacing requirements between devices may be used.

The connectors may be attached to the surfaces of the electronic devices by a variety of means. In one embodiment, the connectors are fastened to the surfaces by a set of screw type fasteners. In another embodiment, the connectors are sonically welded to the surfaces. In yet another embodiment, the connectors are trapped against the surfaces from the interior of the device such that the connectors are not able to move. In this embodiment, openings of sufficient size for the body of the connectors, but not the base of the connectors, to fit through are located in the surfaces of the device. One or more components inside the devices exert mechanical force against the connectors to keep the bases pressed against the opening. This keeps the connectors from moving both in the perpendicular or parallel axis to the surface on which they are located.

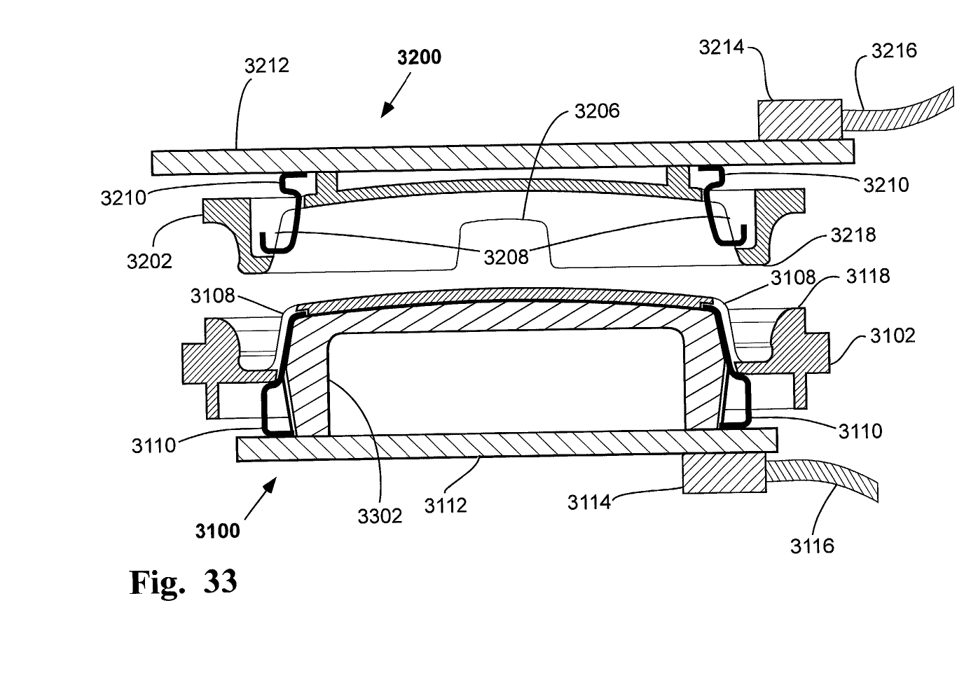

FIG. 33 is a cross-sectional view of plug connector 3100 in proximity to receptacle connector 3200. Circular housing 3202 of receptacle connector 3200 contains set of openings 3208 through which set of contacts 3210 is accessible. In addition, circular housing 3102 of plug connector 3100 also contains set of openings 3108 through which set of contacts 3110 is accessible. Set of contacts 3110 are supported by a contact support 3302 such that set of contacts 110 do not substantially move when set of contacts 3210 comes into connection with set of contacts 3110. Instead, set of contacts 3210 is able to deflect. In another embodiment, set of contacts 3110 is unsupported and is also able to deflect. In yet another embodiment, set of contacts 3210 is supported and does not deflect. Set of contacts 3210 has an “S” shape to deflect and to absorb flex.

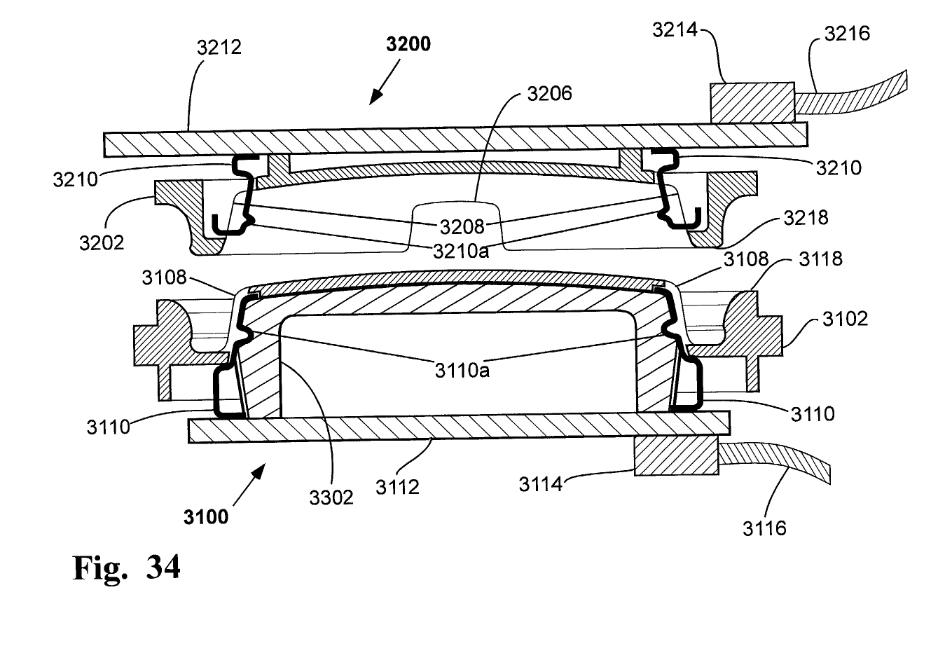

In FIG. 34, an alternate embodiment is illustrated where set of contacts 3110 is shaped to mechanically engage and hold set of contacts 3210 in addition to providing electrical connections. Set of contacts 3110 contains a curved portion mirrored to an oppositely curved portion on set of contacts 3210, where set of contacts 3110 has an indented portion 3110a and set of contacts 3210 has a protruded portion 3210a matched to substantially fit indented portion 3110a. With set of contacts 3210 displaced radially around set of contacts 3110 during the connection of plug connector 3100 to receptacle connector 3200, there is enough force in the deflection of set of contacts 3210 to couple the two sets of contacts. In addition, the engagement of indented portion 3110a in set of contacts 3110 to the protruding portion 3210a in set of contacts 3210 keeps the connectors coupled.

In another embodiment, the contacts in set of contacts 3110 have a protruding portion instead of an indented portion. The protruding portion may or may not be supported by contact support 3302. Also, depending on the configuration of the connectors, not all contacts need to have an indented or protruding portion. This allows the connectors to be snapped together during connection with less force. Thus, for example, every third contact may have a protruding or indented portion. In addition, contacts in both set of contacts 3110 and set of contacts 3210 may contain multiple protruding or indented portions.

In another embodiment, a separate latching mechanism (not shown) is used to mechanically hold the two sets of contacts. This latching mechanism may be integrated with the connectors or located separately. For example, two hooks (not shown) may be used on plug connector 3100 that are matched to two loops (not shown) on receptacle connector 3200, one on each side, to supplement or provide mechanical fastening when the connectors are engaged. Also, a set of detents, matched to a set of protrusions, may be used on the connectors either along with or in place of the latching mechanism created by the protruding and indented portions in the contacts.

In yet another embodiment, plug connector 3100 includes a protective sheath (not shown) that retracts when plug connector 3100 connects to receptacle connector 3200. The sheath protects the connectors on plug connector 3100 and may have a mechanical or spring-loaded catch for releasing the sheath. Receptacle connector 3200 may also have a protective sheath such that either plug connector 3100, receptacle connector 3200, or both may have protection for the contacts.

Although specific devices are shown for the purposes of description, it will be appreciated that the present invention may be employed with any type of electronic device, including, without limitation, consumer electronics, computer or audio systems, and any type of additional components.

What is claimed is:

1. A housing for a device comprising:
a first surface having:
a connector disposed thereon, the connector configured to mechanically couple to an oppositely mated connector on a second surface of a second device; and,
a set of surface features disposed thereon, the set of surface features configured to engage an oppositely mirroring set of surface features on the second surface;
wherein when the device is stacked with the second device, the connector and the set of surface features of the first surface interact with the oppositely mated connector and the oppositely mirroring set of surface features on the second surface, respsectively, to prevent vertical separation and horizontal dislocation between the device and the second device.
